(19) United States
(12) Patent Application Publication
(10) Pub. No.: US 2026/0184041 A1
(43) Pub. Date: Jul. 2, 2026

(54) MULTILAYER ABSORBENT COMPOSITE HAVING IMPROVED PERFORATION RESISTANCE

(71) Applicants: Fitesa Simpsonville, Inc., Simpsonville, SC (US); Fitesa High Point Inc., High Point, NC (US)

(72) Inventors: Allan Henrique Rodrigues Alves, Greenville, SC (US); Dave Rohrbach, Fountain Inn, SC (US); Rene Alberto Ruschel, Greer, SC (US); Felipe Pappis, Simpsonville, SC (US); Yadong Liu, Greensboro, NC (US); Marc Newman, Simpsonville, SC (US); Lijuan Chen, Greensboro, NC (US); Donovan Hayes, Winston Salem, NC (US)

(73) Assignees: Fitesa Simpsonville, Inc., Simpsonville, SC (US); Fitesa High Point Inc., High Point, NC (US)

(21) Appl. No.: 19/435,856

(22) Filed: Dec. 30, 2025

Related U.S. Application Data
(60) Provisional application No. 63/739,934, filed on Dec. 30, 2024.

(51) Int. Cl. B32B 5/26; B32B 5/02; B32B 23/10; B32B 27/12; B32B 27/32; B32B 37/14

(52) U.S. Cl. CPC B32B 5/265; B32B 5/022; B32B 23/10; B32B 27/12; B32B 27/32; B32B 37/14; B32B 2250/02; B32B 2250/03; B32B 2250/40; B32B 2262/0207; B32B 2305/30; B32B 2307/54; B32B 2307/558; B32B 2307/72; B32B 2323/10; B32B 2439/70

(57) ABSTRACT

Provided is a multilayer absorbent composite having a cohesive layer and an absorbent layer. The multilayer absorbent composite provides improvements with respect to resistance to the formation of perforations.

### CROSS-REFERENCE TO RELATED APPLICATIONS

The present application claims priority of U.S. Provisional Application No. 63/739,934, filed Dec. 30, 2024, the contents of which is hereby incorporated by reference.

### FIELD

The disclosure relates to absorbent nonwoven fabrics, and in particular, to nonwoven fabrics comprising a blend of cellulose and thermoplastic fibers.

Fibrous nonwoven materials and fibrous nonwoven composite materials are widely used in disposable wipers. Several methods are used for producing these fibrous nonwoven materials. In one approach, called airlaid, cellulosic fibers are bonded together into a web using an adhesive emulsion. This web must be dried to remove the water and set the adhesive. The resulting web tends to be stiff, due to the presence of the adhesive that binds the fibers.

Another approach, called spunlacing, employs jets of high velocity water to mechanically interlock the fibers in the web. This process commonly uses staple fibers and wood fibers as components in the web. Continuous filaments produced by the spunbond process can also be combined with wood fibers in the spunlacing process. Because adhesive is not commonly used in the spunlacing process, the fibers have substantial freedom to bend and twist, and the resulting webs are soft and drapeable. However, synthetic fibers are significantly more expensive than wood fibers and the spunlacing process has high capital and operating costs.

A third approach used to prepare absorbent nonwovens is to form a blend of absorbent fibers and synthetic fibers produced by the meltblowing process. This type of pulp-polymer integrated composite, called coform, consists of an air formed matrix comprising meltblown microfibers having an average diameter of less than 10 microns, and a multiplicity of individualized absorbent fibers such as, for example, wood pulp fibers, disposed throughout the matrix of polymer microfibers and engaging at least some of the microfibers to space the microfibers apart from each other. The absorbent fibers are interconnected by and held captive within the matrix of microfibers by mechanical entanglement of the microfibers with the absorbent fibers, the mechanical entanglement and interconnection of the microfibers and absorbent fibers alone forming a coherent integrated fibrous structure. These materials are prepared according to the descriptions in U.S. Pat. No. 4,100,324 to Anderson et al. Patents describing the use of coform nonwoven materials and composite fabrics incorporating coform layers include U.S. Pat. Nos. 4,663,220; 4,784,892; 4,906,513; 5,952,251; 6,028,018; 6,946,413 and U.S. Patent Publication Application No. U.S. 2005/0266760A1. Generally, coform nonwovens have demonstrated good absorbency properties and have been successfully used in the manufacture of absorbent wipes.

Despite the advantageous properties of many commercially available coform nonwoven materials, there still exist a need to develop fibrous nonwoven composite materials having improved absorbency and mechanical properties, such as strength.

### SUMMARY

Certain embodiments of the disclosure may help provide a multilayer absorbent composite having improved mechanical properties, such as perforation resistance, strength, elongation, absorbency, and softness.

In certain embodiments, a multilayer absorbent composite is provided in which the composite comprises a first cohesive layer selected from the group consisting of a nonwoven fabric and a film, and an absorbent layer overlying the first cohesive layer, the absorbent layer comprising a blend of meltblown fibers and a solid additive, wherein the multilayer absorbent composite exhibits a wet Mullen Burst Strength from about 10 psi or greater.

In certain embodiments, the first cohesive layer comprises a nonwoven fabric selected from the group consisting of spunbond fabric, a meltblown fabric, a carded fabric, a resin bonded fabric, a cellulose-based fabric, and a multilayer composite fabric, such as a multilayer laminate having a spunbond-meltblown-spunbond structure or spunbond-meltblown structure.

In certain embodiments, the first cohesive layer comprises a film.

In certain embodiments, the basis weight of the cohesive layer is from about 6 to 30 gsm, such as from about 10 to 18 gsm.

In some embodiments, fibers of the first cohesive layer comprise polypropylene.

In some embodiments, the multilayer absorbent composite comprises first and second absorbent layers and the cohesive layer is sandwiched between the first and second absorbent layers.

In certain embodiments, the cohesive layer comprises a cellulose-based tissue layer. In some embodiments, the absorbent layer is sandwiched between a pair of tissue layers. When present, the tissue layer may have a basis weight from about from about 10 to 30 gsm, with a basis weight from 12 to 24 gsm, and more particularly, from about 14 to 18 gsm.

In certain embodiments, the solid additive of the absorbent layer comprises pulp fibers. In some embodiments, the meltblown fibers of the absorbent layer comprise a polymeric blend of a polypropylene resin and an elastomeric polyolefin. When present, the elastomeric polyolefin may be selected from the group consisting of a propylene-alpha-olefin copolymer and a low isotacticity polypropylene polymer.

In certain embodiments, at least a portion of the meltblown fibers comprise a blend of a polypropylene resin and an elastomeric polyolefin in which the polypropylene resin has a molecular weight ranging from any of 120,000 to 300,000 g/mol, a melting temperature from about 150° C. to about 175° C., and wherein the polypropylene resin comprises a Ziegler-Natta catalyzed polypropylene, a metallocene catalyzed polypropylene, or a blend thereof, the elastomeric polypropylene being present in the polymer blend in an amount ranging from about 2 to 30 weight percent, based on the total weight of the polymer blend, and the elastomeric polyolefin is selected from the group consisting of a propylene-alpha-olefin copolymer and a low isotacticity polypropylene polymer.

In certain embodiments, the multilayer absorbent composite exhibits a wet machine direction tensile strength (MDT) ranging from about 15 to 60 N/5 cm, and in particular, from about 30 to 45 N/5 cm, and more particularly, from about 25 to 40 N/5 cm. Such as from about 25 to 60 N/5 cm, or from about 35 to 40 N/5 cm.

In certain embodiments, the multilayer absorbent composite exhibits a dry and/or wet machine direction tensile strength (MDT) ranging from about 10 to 65 N/5 cm, particular, from about 18 to 60 N/5 cm, and in particular, from about 30 to 45 N/5 cm, and more particularly, from about 35 to 40 N/5 cm.

In certain embodiments, the multilayer absorbent composite exhibits a wet machine direction elongation (MDE) ranging from about 30 to 100%, and in particular, from about 35 to 75%, and more 15. The multilayer absorbent composite according to one or more of the preceding particularly, from about 50 to 75%.

In certain embodiments, the multilayer absorbent composite exhibits a dry and/or wet machine direction elongation (MDE) ranging from about 20 to 100, and in particular, from about 30 to 100%, such as from about 35 to 75%, and more particularly, from about 50 to 75%.

In certain embodiments, the multilayer absorbent composite exhibits a dry and/or wet cross direction tensile strength (CDT) ranging from about 10 to 25 N/5 cm, and in particular, from about 12 to 20 N/5 cm, and more particularly, from about 14 to 18 N/5 cm.

In certain embodiments, the multilayer absorbent composite exhibits a wet cross direction tensile strength (CDT) ranging from about 6 to 30 N/5 cm or 10 to 25 N/5 cm, and in particular, from about 12 to 20 N/5 cm, and more particularly, from about 14 to 18 N/5 cm.

In certain embodiments, the multilayer absorbent composite exhibits a wet cross direction elongation (CDE) ranging from about 60 to 100%, and in particular, from about 62 to 85%, and more particularly, from about 70 to 80%.

In certain embodiments, the multilayer absorbent composite exhibits a dry and/or wet cross direction elongation (CDE) ranging from about 40 to 120%, and in particular, from about 55 to 85%, and more particularly, from about 60 to 80%.

In certain embodiments, the multilayer absorbent composite exhibits a wet Mullen Burst strength ranging from about 16 to 24 psi, and in particular, from about 17 to 20 psi, and more particularly, from about 18 to 19 psi.

In certain embodiments, the multilayer absorbent composite exhibits a dry and/or wet Mullen Burst strength greater than 10 psi, such as a Mullen Burst Strength ranging from about 16 to 24 psi, and in particular, from about 17 to 20 psi, and more particularly, from about 18 to 19 psi.

In certain embodiments, the multilayer absorbent composite comprises an interconnecting network of absorbent beads comprising a super absorbent polymer.

In certain embodiments, the multilayer absorbent composite exhibits a wet Mullen Burst Strength greater than 10 psi, such as from about 16 to 24 psi.

In certain embodiments, the multilayer absorbent composite exhibits two or more of the following:
i) a wet machine direction tensile strength (MDT) ranging from about 15 to 60 N/5 cm, and in particular, from about 20 to 45 N/5 cm, and more particularly, from about 25 to 40 N/5 cm;
ii) a wet machine direction elongation (MDE) ranging from about 30 to 100%, and in particular, from about 35 to 75%, and more particularly, from about 50 to 75%;
iii) a wet cross direction tensile strength (CDT) ranging from about 10 to 25 N/5 cm, and in particular, from about 12 to 20 N/5 cm, and more particularly, from about 14 to 18 N/5 cm;
iv) a wet cross direction elongation (CDE) ranging from about 60 to 100%, and in particular, from about 62 to 85%, and more particularly, from about 70 to 80%; and
v) a wet Mullen Burst strength ranging from about 12 to 24 psi, and in particular, from about 17 to 20 psi, and more particularly, from about 18 to 19 psi.

In certain embodiments, the multilayer absorbent composite exhibits two or more of the following:
i) increase in wet MDT ranging from about 225 to 300%, and in particular, from about 250 to 280% in comparison to an identically/similarly prepared nonwoven fabric that does not include the cohesive layer;
ii) an increase in MDE ranging from about 75 to 180%, and in particular, from about 100 to 150% in comparison to an identically/similarly prepared nonwoven fabric that does not include the cohesive layer;
iii) an increase in wet CDT ranging from about 20 to 200%, and in particular, from about 70 to 175% in comparison to an identically/similarly prepared nonwoven fabric that does not include the cohesive layer;
iv) an increase in wet CDE ranging from about 20 to 75%, and in particular, from about 25 to 60% in comparison to an identically/similarly prepared nonwoven fabric that does not include the cohesive layer; and
v) an increase in wet Mullen Burst Strength ranging from about 25 to 125%, and in particular, from about 30 to 100% in comparison to an identically/similarly prepared nonwoven fabric that does not include the cohesive layer.

In certain embodiments, the multilayer absorbent composite exhibits an increase in wet MDT ranging from about 225 to 300%, and in particular, from about 250 to 280% in comparison to an identically/similarly prepared nonwoven fabric that does not include the cohesive layer.

In certain embodiments, the multilayer absorbent composite exhibits an increase in MDE ranging from about 75 to 180%, and in particular, from about 100 to 150% in comparison to an identically/similarly prepared nonwoven fabric that does not include the cohesive layer.

In certain embodiments, the multilayer absorbent composite exhibits an increase in wet CDT ranging from about 20 to 200%, and in particular, from about 70 to 175% in comparison to an identically/similarly prepared nonwoven fabric that does not include the cohesive layer.

In certain embodiments, the multilayer absorbent composite exhibits an increase in wet CDE ranging from about 20 to 75%, and in particular, from about 25 to 60% in comparison to an identically/similarly prepared nonwoven fabric that does not include the cohesive layer.

In certain embodiments, the multilayer absorbent composite exhibits an increase in wet Mullen Burst Strength ranging from about 25 to 125%, and in particular, from about 30 to 100% in comparison to an identically/similarly prepared nonwoven fabric that does not include the cohesive layer.

In certain embodiments, the absorbent layer defines a first exterior surface of the multilayer absorbent composite, the first exterior layer comprising and/or consisting of a blend of meltblown and pulp fibers, and the first exterior surface exhibits a static COF from about 0.145 to 0.165 and a dynamic COF from about 0.05 to 0.080; and the cohesive layer defines a second exterior surface comprising meltblown fibers in which the second exterior surface exhibits a static COF from about 0.225 to 0.275 and a dynamic COF from about 0.135 to 0.175.

In certain embodiments of the multilayer absorbent composite, the first exterior surface exhibits a static COF that is from about 30 to 90% greater than that of the opposite exterior surface of the multilayer absorbent composite, and a dynamic COF that is from about 120 to 160% greater than that of the opposite exterior surface of the multilayer absorbent composite.

Aspects of the disclosure are directed to the use of the multilayer absorbent composite in an absorbent article, such as a wipe or as an absorbent mat in a package assembly for a food product.

Certain aspects of the disclosure are directed to a product assembly adapted to absorb liquids exuded from a product, comprising:

a substantially rigid support member having an upper surface upon which a product may be placed, and an opposing lower surface; and

an multilayer absorbent composite positioned overlying said support member, the multilayer absorbent composite comprising a first cohesive layer selected from the group consisting of a nonwoven fabric and a film, and an absorbent layer overlying the first cohesive layer, the absorbent layer comprising a blend of meltblown fibers and a solid additive, wherein the multilayer absorbent composite exhibits a wet Mullen Burst Strength from about 10 psi or greater.

In certain aspects, the product assembly disclosure provides a product assembly in which a food product disposed overlying the multilayer absorbent composite and an outer film layer attached to the support member and enclosing the food product therein.

In certain aspects of the food product, the first cohesive layer comprises a nonwoven fabric selected from the group consisting of spunbond fabric, a meltblown fabric, a carded fabric, a resin bonded fabric, a cellulose-based fabric, and a multilayer composite fabric.

Certain aspects of the disclosure provide a method of preparing a multilayer absorbent composite comprising the steps of:
providing a cohesive layer selected from the group consisting of a nonwoven fabric and a film;
depositing an absorbent layer comprising a blend of meltblown fibers and a solid additive overlying the cohesive layer, wherein the multilayer absorbent composite exhibits a dry/wet Mullen Burst Strength greater than 10 psi.

Certain aspects of the method provide a multilayer absorbent composite having one or more combination of previously mentioned properties, structural configurations and materials. wet MDT ranging from about 225 to 300%, and in particular, from about 250 to 280% in comparison to an identically/similarly prepared nonwoven fabric that does not include the cohesive layer.

### BRIEF DESCRIPTION OF THE DRAWINGS

Having thus described the invention in general terms, reference will now be made to the accompanying drawings, which are not necessarily drawn to scale, and wherein:

FIG. 1 is a cross-sectional view of a multilayer absorbent article in accordance with at least one embodiment of the disclosure;

FIG. 2 is a cross-sectional view of a multilayer absorbent article in accordance with at least one embodiment of the disclosure;

FIG. 3 is a cross-sectional view of a multilayer absorbent article in accordance with at least one embodiment of the disclosure;

FIG. 4 is a cross-sectional view of a multilayer absorbent article in accordance with at least one embodiment of the disclosure;

FIG. 5 is a schematic illustration of a system for preparing a a multilayer composite article in accordance with at least one embodiment of the disclosure.

FIGS. 6A-6C are representative embossing patterns that may be applied to the surfaces of the multilayer absorbent composite; and

FIG. 7 is a schematic illustration of a system for the preparation of a multilayer composite article in accordance with at least one embodiment of the disclosure; and

FIG. 8 is directed to product package assembly comprising a multilayer absorbent composite in accordance with at least one aspect of the disclosure.

### DETAILED DESCRIPTION

The invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Each embodiment disclosed herein is contemplated as being applicable to each of the other disclosed embodiments. All combinations and sub-combinations of the various elements described herein are within the scope of the invention.

It is understood that where a parameter range is provided, all integers within that range, and tenths and hundredths thereof, are also provided by the invention. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%.

As used herein, the terms about,” “approximately,” and “substantially” in the context of a numerical value or range means±10% of the numerical value or range recited or claimed, and in particular, encompasses values within a standard margin of error of measurement (e.g., SEM) of a stated value or variations±0.5%, 1%, 5%, or 10% from a specified value.

For the purposes of the present application, the following terms shall have the following meanings:

The term “fiber” can refer to a fiber of finite length or a filament of infinite length.

As used herein, the term “monocomponent” refers to fibers formed from one polymer or formed from a single blend of polymers. Of course, this does not exclude fibers to which additives have been added for color, anti-static properties, lubrication, hydrophilicity, liquid repellency, etc.

As used herein, the term “multicomponent” refers to fibers formed from at least two polymers (e.g., bicomponent fibers) that are extruded from separate extruders. The at least two polymers can each independently be the same or different from each other, or may be a blend of polymers. The polymers are arranged in substantially constantly positioned distinct zones across the cross-section of the fibers. The components may be arranged in any desired configuration, such as sheath-core, side-by-side, pie, island-in-the-sea, and so forth. Various methods for forming multicomponent fibers are described in U.S. Pat. No. 4,789,592 to Taniguchi et al. and U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference.

As used herein the terms “nonwoven,” “nonwoven web” and “nonwoven fabric” refer to a structure or a web of material which has been formed without use of weaving or knitting processes to produce a structure of individual fibers or threads which are intermeshed, but not in an identifiable, repeating manner. Nonwoven webs have been, in the past, formed by a variety of conventional processes such as, for example, meltblown processes, spunbond processes, and staple fiber carding processes.

As used herein, the term “meltblown” refers to a process in which fibers are formed by extruding a molten thermoplastic material through a plurality of fine, usually circular, die capillaries into a high velocity gas (e.g. air) stream which attenuates the molten thermoplastic material and forms fibers, which can be to microfiber diameter. Thereafter, the meltblown fibers are carried by the gas stream and are deposited on a collecting surface to form a web of random meltblown fibers. Meltblown fibers can be prepared using known processes, such as the use of meltblown dies including knife edge dies and multirow meltblown dies. Examples of systems using multirow meltblown dies are described in U.S. Pat. Nos. 5,476,616, 10,513,801, 9,303,334 and 10,633,774, the contents of which are hereby incorporated by reference.

As used herein, the term “laminate” refers to a nonwoven fabric that includes two or more layers that are joined, directly or indirectly, to form a composite sheet material.

As used herein, the term “machine direction” or “MD” refers to the direction of travel of the nonwoven web during manufacturing.

As used herein, the term “cross direction” or “CD” refers to a direction that is perpendicular to the machine direction and extends laterally across the width of the nonwoven web.

As used herein, and unless indicated to the contrary, the term “molecular weight” refers to the weight average molecular weight (Mw), and is expressed in grams/mol. The weight average molecular weight can be determined using commonly known techniques, such as gel permeation chromatography (GPC).

As used herein, the term “spunbond” refers to a process involving extruding a molten thermoplastic material as filaments from a plurality of fine, usually circular, capillaries of a spinneret, with the filaments then being attenuated and drawn mechanically or pneumatically. The filaments are deposited on a collecting surface to form a web of randomly arranged substantially continuous filaments which can thereafter be bonded together to form a coherent nonwoven fabric. The production of spunbond non-woven webs is illustrated in patents such as, for example, U.S. Pat. Nos. 3,338,992; 3,692,613, 3,802,817; 4,405,297 and 5,665,300. In general, these spunbond processes include extruding the filaments from a spinneret, quenching the filaments with a flow of air to hasten the solidification of the molten filaments, attenuating the filaments by applying a draw tension, either by pneumatically entraining the filaments in an air stream or mechanically by wrapping them around mechanical draw rolls, depositing the drawn filaments onto a foraminous collection surface to form a web, and bonding the web of loose filaments into a nonwoven fabric. The bonding can be any thermal or chemical bonding treatment, with thermal point bonding being typical.

As used herein “thermal point bonding” involves passing a material such as one or more webs of fibers to be bonded between a heated calender roll and an anvil roll. The calender roll is typically patterned so that the fabric is bonded in discrete point bond sites rather than being bonded across its entire surface.

As used herein, the terms “through air bonded” or “through air bonding” refers to a type of thermal bonding in which a material to be bonded, such as a web of fibers, is subjected to the application of heated gas, such as air, in which the temperature of the heated gas is above the softening or melting temperature of at least one polymer component of the material being bonded. The heated gas causes the at least one polymer component to soften, and under some circumstances, to become semi-molten such that polymers of adjacent fibers fuse together to form thermal bonds. Air thermal bonding may also involve passing a material through a heated oven.

As used herein the term “polymer” generally includes, but is not limited to, homopolymers, copolymers, such as, for example, block, graft, random and alternating copolymers, terpolymers, etc. and blends and modifications thereof. Furthermore, unless otherwise specifically limited, the term “polymer” shall include all possible geometrical configurations of the material, including isotactic, syndiotactic and random symmetries.

Certain embodiments of the disclosure are directed to a multilayer sheet material having improved properties with respect to absorbency, perforation resistance, and softness. In addition, certain embodiments of the disclosure also provide a multilayer sheet material having improved abrasion resistance. In particular, certain embodiments of the disclosure are directed to an absorbent multilayer sheet material having improved perforation resistance as evidenced by having a substantial increase in Mullen Burst Strength.

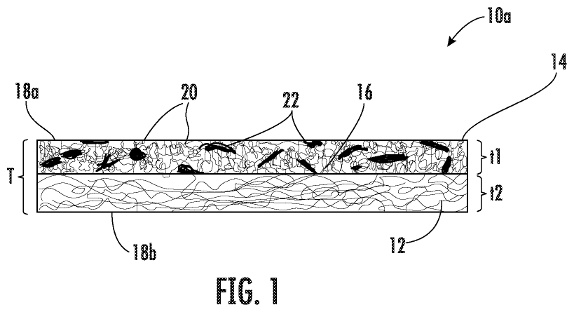

With reference to FIG. 1, a sheet material comprising a multilayer absorbent composite in accordance with one or more embodiments of the present disclosure is illustrated and broadly designated by reference character 10a. The multilayer absorbent composite 10a comprises a first cohesive layer 12 and an absorbent layer 14 comprising a plurality of thermoplastic fibers 20 that are intermixed with a plurality of solid additives 22, such as cellulose fibers. Suitable examples of solid additives are discussed in greater detail below.

The multilayer composite 10a comprises a thickness “T” that collectively includes the thickness t2 of the cohesive layer 12 and the thickness t1 of the absorbent layer 14. In the embodiment illustrated in FIG. 1, the absorbent layer 14 overlies the first cohesive layer 12 at interface 16. The multilayer absorbent composite 10a includes a first exterior surface 18a, and a second exterior surface 18b.

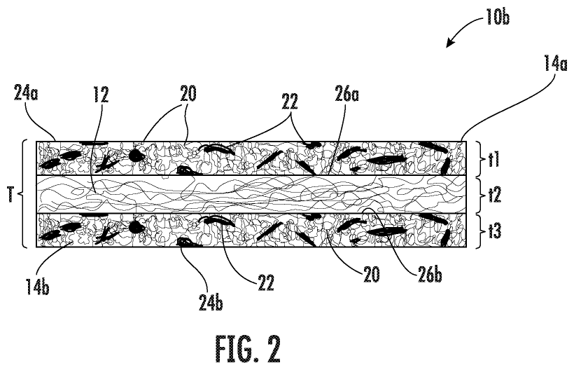

With reference to FIG. 2, a further embodiment of a multilayer absorbent composite in accordance with one or more embodiments of the disclosure is shown and broadly designated by reference character 10b. In this illustrated embodiment, the multilayer absorbent composite 10b comprises a first cohesive layer 12 that is sandwiched between a pair of absorbent layers 14a, 14b. The pair of absorbent layers each comprise a plurality of thermoplastic fibers 20 that are intermixed with a plurality of solid additives 22.

The multilayer composite 10b comprises a thickness “T” that collectively includes the thickness t1 of the cohesive layer 12 and the thickness t2, t3 of the absorbent layers 14a, 14b. In the embodiment illustrated in FIG. 2, the absorbent layer 14a overlies the first cohesive layer 12 at interface 16. The multilayer absorbent composite 10a includes a first exterior surface 24a, which is an outer surface of the absorbent layer 14a and a second exterior surface 24b, which is an outer surface of the absorbent layer 14b. The absorbent layers 14a, 14b, are joined to the cohesive layer 12 at interfaces 26a, 26b, respectively.

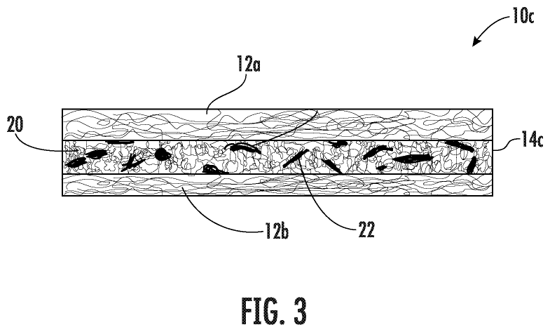

With reference to FIG. 3, an embodiment of a multilayer absorbent composite 10c is shown in which the multilayer absorbent composite 10c comprises a pair of cohesive layers 12a, 12b and an absorbent layer 14c that is disposed between the pair of cohesive layers. As in the previously discussed embodiments, the absorbent layer comprises a plurality of thermoplastic fibers 20 that are intermixed with a plurality of solid additives 22. The pair of cohesive layers 12a, 12b, may be the same as each other or may be different.

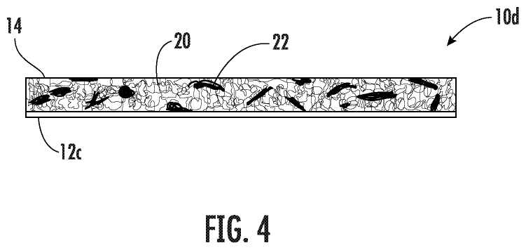

With reference to FIG. 4, a further embodiment of a multilayer absorbent composite 10d is shown in which the multilayer absorbent composite 10d comprises a cohesive layer comprising a polymeric film layer. As shown, the absorbent layer 14 overlies the cohesive layer 12c. As in the embodiments discussed previously, the cohesive layer 12c may be disposed between a pair of absorbent layers (for example, as shown in FIG. 2), or an absorbent layer may be disposed between a pair of cohesive layers (for example, as shown in FIG. 3).

### Cohesive Layer

In certain embodiments, the cohesive layer comprises a polymeric material, such as a synthetic polymer or natural polymer, having sufficient mechanical properties that, when joined with one or more absorbent layers, helps prevent perforation of the multilayer absorbent composite. In particular, the cohesive layer may improve the cohesiveness of the multilayer absorbent composite by helping to prevent or reduce the formation of tears, punctures, slits, holes, or the like in the multilayer absorbent composite, and hence, in the absorbent layer. In particular, the cohesive layer imparts isotropic and/or anisotropic tensile strength and elongation. As a consequence of these improvements in properties, multilayer absorbent composites in accordance with embodiments of the disclosure may advantageously packaged in a variety of containers, such as containers in which the absorbent article is z-folded in a flat package configuration or when detached from a continuous roll in a canister type package.

Suitable materials for the cohesive layer may include various nonwoven fabrics, such as a spunbond fabric, a meltblown fabric, a carded fabric, a resin bonded fabric, a spunlace fabric, a composite/laminate comprising two or more nonwoven layers (which may be the same or different from each other), such as a spunbond-meltblown (SM) composite, a spunbond-meltblown-spunbond (SMS) composite, or a spunbond-meltblown-meltblown-spunbond (SMMS) composite), a spunbond-spunbond-meltblown-meltblown-spunbond (SSMMS), or a spunbond-spunbond-meltblown-spunbond (SSMS) composite, or the like, cellulose-based tissue layers, and combinations thereof.

In embodiments in which the cohesive layer comprises one or more nonwoven layers or tissue layers, the cohesive layer may have a basis weight from about 5 grams per square meter (gsm) to about 30 gsm, depending on the number of layers in the fabric and the composition of each layer. In certain embodiments, the cohesive layer may have a basis weight ranging from about 8 to 20 gsm, and in particular, from about 10 to 18 gsm, with a basis weight between about 12 to 15 gsm being somewhat more preferred.

In certain embodiments in which the cohesive layer comprises a cellulose-based material, such as a tissue layer, the basis weight may range from about 10 to 30 gsm, with a basis weight from 12 to 24 gsm, and more particularly, from about 14 to 18 gsm being somewhat more preferred.

The thickness of the cohesive layer generally ranges from about 0.1 to 1.2 mm, and in particular, from about 0.2 to 0.6 mm, and more particularly, from about 0.3 to 0.6 mm.

Generally, the cohesive layer constitutes a minor proportion of the multilayer absorbent composite based on the total weight of the multilayer absorbent composite. In certain embodiments, the cohesive layer comprises from about 5 to 50 weight percent of the multilayer absorbent composite based on the total and weight of the multilayer absorbent composite, and in particular, from about 8 to 30 weight percent, and more particularly, from about 10 to 20 weight percent, based on the total weight of the multilayer absorbent composite.

The cohesive layer may comprise a plurality of thermoplastic fibers that are bonded together to form a coherent web. In certain embodiments, the thermoplastic fibers of the cohesive layer may be prepared using a variety of different spinning techniques, including meltblown fibers, spunbond fibers, airlaid fibers, carded staple fibers, and the like. In a preferred embodiment, the fibers of the composite nonwoven comprise meltblown and/or spunblown fibers.

Suitable polymers for preparing the thermoplastic fibers may be synthetic fibers, bio-polymer based fibers, or combinations and blends thereof. Examples of suitable fibers are discussed below in connection with polymers that may be used in the preparation of the thermoplastic fibers for use in the absorbent layer.

In certain embodiments, the thermoplastic fibers comprising the cohesive layer and/or found in an outer layer of the cohesive layer comprise the same or similar polymer used in the preparation of the thermoplastic fibers of the absorbent layer. For example, in certain embodiments the cohesive layer may have an SMS configuration in which the spunbond layers include thermoplastic fibers comprised of a polypropylene, and the thermoplastic fibers of the absorbent layer also comprise polypropylene.

In certain embodiments, the cohesive layer may comprise a polymeric film. Suitable films may include both cast, extruded, vacuum formed films. In addition, the film layer may be continuous or discontinuous. In certain embodiments, the film layer may include apertures or microperforations that permit the passage of fluid from one side of the multilayer absorbent composite to an opposite side. In certain embodiments, the film may be monolithic and breathable.

When present, the film layer may have a thickness ranging from about 0.1 to 1.2 mm, and in particular, from about 0.4 to 1.0, and more particularly, from about 0.6 to 0.9 mm.

When present, the film layer may have a basis weight from about 6 to 36 gsm, and in particular, from about 8 to 18, and more particularly, from about 10 to 14 gsm.

Suitable examples of polymers that may be used in the film include those mentioned with respect to the thermoplastic fibers. In particular, suitable polymers may include polyolefins, polypropylenes, polyethylenes, polybutylene, polyesters, such as polyethylene terephthalate, bio-polymers, and the like.

### Absorbent Layer

In certain embodiments, the absorbent layer(s) of the multilayer absorbent composite comprises a blend of thermoplastic fibers and a solid additive.

The absorbent layer may comprise any suitable amount of fibers and any suitable amount of solid additives. For example, the composite nonwoven may comprise from about 10% to about 70% and/or from about 20% to about 60% and/or from about 30% to about 50% by dry weight of the composite nonwoven of fibers and from about 90% to about 30% and/or from about 80% to about 40% and/or from about 70% to about 50% by dry weight of the composite nonwoven of solid additives, such as wood pulp fibers.

In certain embodiments, the absorbent layer may have a basis weight from about 30 grams per square meter (gsm) to about 70 gsm, depending on the number of absorbent layers in the multilayer absorbent composite. In certain embodiments, the absorbent layer may have a basis weight ranging from about 40 to 60 gsm, and in particular, from about 45 to 55 gsm, with a basis weight between about 48 to 52 gsm being somewhat more preferred.

The thickness of the absorbent layer generally ranges from about 0.3 to 1.5 mm, and in particular, from about 0.5 to 1.3 mm, and more particularly, from about 0.6 to 1.2 mm.

Generally, the absorbent layer constitutes a major proportion of the multilayer absorbent composite based on the total weight of the multilayer absorbent composite. In certain embodiments, the absorbent layer comprises from about 50 to 95 weight percent of the multilayer absorbent composite based on the total and weight of the multilayer absorbent composite, and in particular, from about 70 to 92 weight percent, and more particularly, from about 80 to 90 weight percent, based on the total weight of the multilayer absorbent composite.

In certain embodiments, the solid additive of the absorbent layer comprises wood or pulp fibers, super absorbent polymer particles or fibers, and combinations thereof.

In certain embodiments, the solid additive comprises fibers formed by a variety of pulping processes, such a kraft pulp, sulfite pulp, thermo-mechanical pulp, etc. Suitable pulps include treated and untreated pulps. The pulp fibers may include softwood fibers having an average fiber length of greater than 1 millimeter (mm) and particularly from about 2 mm to 5 mm. Such softwood fibers can include, but are not limited to: northern softwood, southern softwood, redwood, red cedar, hemlock, pine (e.g. southern pines), spruce (e.g. black spruce), combinations thereof, and so forth. Exemplary commercially available pulp fibers suitable in the present invention include those available from Georgia Pacific. Hardwood fibers, such as eucalyptus, maple, birch, aspen, and so forth, can also be used. In certain instances, eucalyptus fibers may be particularly desired to increase the softness of the hybrid non-woven web. Eucalyptus fibers can also enhance the brightness, increase the opacity, and change the pore structure of the hybrid non-woven web to increase its wicking ability. Moreover, if desired, secondary fibers obtained from recycled materials may be used, such as fiber pulp from sources such as, for example, newsprint, reclaimed paperboard and office waste.

Further, other natural fibers can also be used in the present invention, such as abaca, sabai grass, milkweed floss, pineapple leaf, sisal, hemp, and so forth. In addition, in some instances, synthetic fibers can also be utilized. Additional fibers include cotton fibers and cotton linters in whole or blends with the foregoing discussed natural fibers.

In certain embodiments, the solid additives may comprise natural fibers. Generally, natural fibers are derived from plants or animals. Natural fibers derived from plants typically comprise cellulose materials, and may include cotton fibers, cotton linters, flax fibers, hemp fibers, grass fibers, such as elephant grass, jute fibers, abaca fibers, coir fibers, ramie fibers (also known as Chinese grass), sisal fibers, and the like.

In certain embodiments, the solid additive may comprise a pulp derived from bamboo.

In addition, natural fibers derived from animals may include wool, silk, camel hair, alpaca wool, cashmere, angora wool, and the like. In a preferred embodiment, the natural fibers comprise cotton fibers.

In certain embodiments, the solid additive may comprise a blend of cellulose fibers and non-cellulose fibers. A wide variety of different cellulose materials may be used for the cellulose fibers. Fibers from Esparto grass, bagasse, kemp, flax, and other lignaceous and cellulose fiber sources may be utilized. Other fibers include absorbent natural fibers made from regenerated cellulose, polysaccharides or other absorbent fiber-forming compositions. In certain embodiments, the natural fibers comprise non-bleached cotton fibers having fiber lengths ranging from about 15 to 38 mm.

When present, suitable materials for the non-cellulose fibers for use as the solid additive may comprise monocomponent or multicomponent fibers, or mixtures of moncomponent and multicomponent fibers. In a preferred embodiment, the non-cellulose fibers comprise bicomponent fibers having a sheath/core configuration.

In some embodiments, the solid additive may comprise staple fibers. Staple fibers typically have lengths ranging from about 10 to 65 mm, and in particular, from about 20 to 15 mm, and more particularly, from about 25 to 50 mm.

Besides or in conjunction with pulp fibers, the solid additive may also include a superabsorbent that is in the form of fibers, particles, gels, coating, etc. Generally speaking, superabsorbents are water-swellable materials capable of absorbing may times their weight in fluids. The superabsorbent may be formed from natural, synthetic and modified natural polymers and materials. Examples of synthetic superabsorbent polymers include the alkali metal and ammonium salts of poly(acrylic acid) and poly(methacrylic acid), poly(acrylamides), poly(vinyl ethers), maleic anhydride copolymers with ethers and alpha-olefins, poly(vinyl pyrrolidone), poly(vinylmorpholinone), poly(vinyl alcohol), and mixtures and copolymers thereof. Further superabsorbents include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and so forth. Mixtures of natural and wholly or partially synthetic superabsorbent polymers may also be useful in the present invention. Particularly suitable superabsorbent polymers are HYSORB 8800AD, available from BASF of Charlotte, N.C., and FAVOR SXM 9300, available from Degrussa Superabsorber of Greensboro, N.C. In addition, natural super absorbents may be used, such as Glucomannan. When present, the natural superabsorbent may comprise 100% of the superabsorbent, or may be blended with synthetic super absorbents.

### Examples of Polymers for the Thermoplastic Fibers

The thermoplastic fibers of the absorbent layer may be prepared using a variety of different spinning techniques, including meltblown fibers, spunbond fibers, airlaid fibers, carded fibers, and the like. In a preferred embodiment, the fibers of the composite nonwoven comprise meltblown fibers.

Meltblown fibers can be prepared using known processes, such as the use of meltblown dies including knife edge dies and multirow meltblown dies. Examples of systems using multirow meltblown dies are described in U.S. Pat. Nos. 5,476,616, 10,513,801, 9,303,334 and 10,633,774, the contents of which are hereby incorporated by reference.

In certain embodiments, the thermoplastic fibers of the composite nonwoven may be continuous or discontinuous. In certain embodiments, the thermoplastic fibers may comprise monocomponent fibers, multicomponent fibers, such as bicomponent, or mixtures of such fibers.

In certain embodiments, the thermoplastic fibers may comprise a biodegradeable polymer, such as polybutylene adipate terephthalate (PBAT). For example, the thermoplastic fibers of one or more of the cohesive layer and the absorbent layer may comprise PBAT.

In some embodiments, the thermoplastic fibers may comprise a biodegradeable and a bio-based polymer, such as poly(3-hydroxybutyrate-co-3-hydroxyhexanoate (PHBH). For example, the thermoplastic fibers of one or more of the cohesive layer and the absorbent layer may comprise PHBH.

The thermoplastic fibers of the absorbent layer may comprise a wide variety of different polymers and polymeric blends.

Examples of suitable polymers for preparing the thermoplastic fibers include polyolefins, such as polypropylene and polyethylene, and copolymers thereof, polyesters, such as polyethylene terephthalate (PET), polytrimethylene terephthalate (PTT), and polybutylene terephthalate (PBT), nylons, polystyrenes, polyurethanes, copolymers, and blends thereof, and other synthetic polymers that may be used in the preparation of fibers. In some embodiment, the polymer can be selected from the group consisting of: polyolefins, polyesters, polyethylene terephthalates, polybutylene terephthalates, polycyclohexylene dimethylene terephthalates, polytrimethylene terephthalates, polymethyl methacrylates, polyamides, nylons, polyacrylics, polystyrenes, polyvinyls, polytetrafluoroethylenes, ultrahigh molecular weight polyethylenes, very high molecular weight polyethylenes, high molecular weight polyethylenes, polyether ether ketones, non-fibrous plasticized celluloses, polyethylenes, polypropylenes, polybutylenes, polymethylpentenes, low-density polyethylenes, linear low-density polyethylenes, high-density polyethylenes, polystyrenes, acrylonitrile-butadiene-styrenes, styrene-acrylonitriles, styrene tri-block and styrene tetra block copolymers, styrene-butadienes, styrene-maleic anhydrides, ethylene vinyl acetates, ethylene vinyl alcohols, polyvinyl chlorides, cellulose acetates, cellulose acetate butyrates, plasticized cellulosics, cellulose propionates, ethyl cellulose, natural fibers, any derivative thereof, any polymer blend thereof, any copolymer thereof or any combination thereof.

In certain embodiments, the polymers for use in the thermoplastic fibers preferably comprise a polyolefin, such as a polypropylene, polyethylene, a blend of a polypropylene and polyethylene, and combinations thereof.

In certain embodiments for the preparation of meltblown fibers, suitable thermoplastic resins may typically have an MFR greater than about 500 g/10 min. For example, in certain embodiments, the polymer may comprise a polyolefin, such as polyethylene or polypropylene, having an MFR that is typically greater than about 500 g/10 min. For example, the polyolefin may have an MFR from about 500 to 2,500 g/10 min, and in particular, from about 1000 to 1500 g/10 min, with an MFR from about 1200 to 1400 g/10 min being somewhat more typical. An example of such a polypropylene is available from Braskem, such as H155 (1250 MFR) g/10 min.

In certain embodiments for the preparation of spunbond fibers, suitable polyolefins may have an MFR that is typically from about 10 to 100 g/10 min, and in particular, from about 20 to 40 g/10 min, with an MFR from about 22 to 38 g/10 min being somewhat more typical. Unless otherwise indicated MFR is measured in accordance with ASTM D-1238.

Examples of such polypropylenes may include those available from ExxonMobil, such as pp 3155 (36 MFR g/10 min., density of 0.90 g/cm³, and Mw 172 k g/mol); pp 3155E5 (36 MFR g/10 min., density of 0.90 g/cm³, and Mw 172 k g/mol); and ACHIEVE™ 3854 (24 MFR g/10 min., density of 0.90 g/cm³). Polypropylenes available from SABIC®, such as SABIC PP 511A (25 MFR g/10 min, density of 0.905 g/cm³), polypropylenes available from Borealis, such as HG475FB (27 MFR g/10 min.), polypropylenes available from Braskem, such as CP360H (34 MFR g/10 min.), polypropylene resins available from Heartland Polymers, such as H5235G (35 MFR g/10 min.) may also be used.

In certain embodiments, the thermoplastic fibers may comprise a multicomponent fiber, such as a bicomponent fiber comprising a first polymer component and a second polymer component in which the second polymer component comprises a blend of polyolefins in which a first polyolefin in the blend has a low MFR, such as less than 100 g/10 min and the second polyolefin in the blend has an MFR greater than the first polyolefin, such as greater than 500 g/10 min, and in particular, greater than 1,000 g/10 min. Typically, the MFR of the blend is less than 50 g/10 min and the MFR ratio of the low MFR polyolefin to the high MFR polyolefin is 1:100, and in particular: 1:20 to 1:50. Typically, the amount of high MFR in the blend is from about 0.5 to 12 weight percent, based on the total weight of the blend, and in particular, from about 2 to 8, weight percent, and more particularly, from about 3 to 6 weight percent, based on the total weight of the blend.

In one such embodiment, the first polymer component comprises a polypropylene polymer having an MFR from about 20 to 40 g/10 min, and the second polymer component comprises a blend of a low MFR polypropylene having an MFR from about 20 to 40 g/10 min and a high MFR polypropylene having an MFR from about 500 to 2,500 g/10 min in which the amount of high MFR polypropylene in the blend is from about 3 to 6 wight percent, based on the total weight of the blend. The polypropylene in the first polymer component may be the same or a different polypropylene as the low MFR polypropylene in the second polymer component. Such fibers when prepared in a side-by-side, eccentric or D-centric configuration may be used to prepare a nonwoven fabric comprising crimped fibers.

In some embodiments, the polyolefin may comprise a polyethylene polymer. Various types of polyethylene polymers may be employed in the fibers of the present invention. As an example, a high density polyethylene, a branched (i.e., non-linear) low density polyethylene, or a linear low density polyethylene (LLDPE) can be utilized. Polyethylenes may be produced from any of the well-known processes, including metallocene and Ziegler-Natta catalyst systems. Suitable polyethylenes may have molecular weights greater than about 100,000 g/mol, and more typically, may have molecular weights ranging from about 150,000 to about 300,000 g/mol. In one embodiment, the polyethylene may have a molecular weights ranging from about 160,000 to about 250,000 g/mol, and in particular, from about 160,000 to about 180,000 g/mol.

In certain embodiments of the invention, the polyethylene component comprises a polyethylene having a density ranging from about 0.90 to 0.97 g/cm³ (ASTM D-792). In particular, preferred polyethyelenes have a density value ranging from 0.93 to 0.965 g/cm³, and more particularly from about 0.94 to 0.965 g/cm³. Examples of suitable polyethylenes included ASPUN™ 6834 (a polyethylene polymer resin having a melt index of 17 g/10 min (ISO 1133) and a density of 0.95 g/cm³ (ASTM D-792)), available from Dow Chemical Company, and HD6908.19 (a polyethylene resin supplied by ExxonMobil having a melt index in the range of 7.5 to 9 g/10 min (ISO 1133) and a density of 0.9610 to 0.9680 g/cm³ (ASTM D-792)).

LLDPE may also be used in some embodiments of the present invention. LLDPE is typically produced by a catalytic solution or fluid bed process under conditions established in the art. The resulting polymers are characterized by an essentially linear backbone. Density is controlled by the level of comonomer incorporated into the otherwise linear polymer backbone. Various alpha-olefins are typically copolymerized with ethylene in producing LLDPE. The alpha-olefins which preferably have four to eight carbon atoms, are present in the polymer in an amount up to about 10 percent by weight. The most typical comonomers are butene, hexene, 4-methyl-1-pentene, and octene. In general, LLDPE can be produced such that various density and melt index properties are obtained which make the polymer well suited for melt-spinning with polypropylene. Preferably, the LLDPE should have a melt index of greater than 10, and more preferably 15 or greater for spunbonded filaments. Particularly preferred are LLDPE polymers having a density of 0.90 to 0.97 g/cm³ and a melt index of greater than 25. Examples of suitable commercially available linear low density polyethylene polymers include those available from Dow Chemical Company, such as ASPUN™ Type 6811 (27 MFR g/10 min, density 0.923 g/cm³), ASPUN™ Type 6834 (17 MFR g/10 min, density of 0.95 g/cm³), ASPUN™ Type 6000 (30 MFR g/10 min, 0.955 g/cm³ density), ASPUN™ Type 6850 (30 MFR g/10 min, 0.955 g/cm³ density), Dow LLDPE 2500 (55 MFR g/10 min, 0.923 g/cm³ density), Dow LLDPE Type 6808A (36 MFR g/10 min, 0.940 g/cm³ density), and the Exact series of linear low density polyethylene polymers from Exxon Chemical Company, such as Exact 2003 (31 MFR g/10 min, density 0.921 g/cm³).

Polymer Blend with an Elastomeric Polymer

In some embodiments, the polymers may be extensible and/or elastic.

In certain embodiments, the thermoplastic fibers of the absorbent layer may comprise a blend of a first polypropylene polymer and an elastomeric polyolefin polymer.

Suitable examples of a first polypropylene polymer are included in the polypropylenes discussed previously.

The amount of the first polypropylene polymer in the polymer blend is typically from about 1 to 99 weight percent, and in particular, from about 5 to 95 weight percent, and more particularly, from about 10 to 90 weight percent, and even more particularly, from about 15 to 85 weight percent of the polymer blend, based on the total weight of the polymer blend.

In certain embodiments, the amount of the first polypropylene comprises from about 50 to 99 weight percent of the polymer blend, based on the total weight of the polymer blend. In certain preferred embodiments, the first polypropylene polymer comprises the balance of the polymer blend and as such, is present in an amount greater than 50 weight percent, based on the total weight of the blend. For example, the amount of the first polypropylene resin may be from about 65 to 99 weight percent, and in particular, from about 70 to 95 weight percent, and more particularly, from about 75 to 90 weight percent, based on the total weight of the polymer blend.

In certain embodiments, the amount of first polypropylene polymer in the polymer blend is at least 50 weight percent, at least 51 weight percent, at least 52 weight percent, at least 53 weight percent, at least 54 weight percent, at least 55 weight percent, at least 56 weight percent, at least 57 weight percent, at least 58 weight percent, at least 59 weight percent, at least 60 weight percent, at least 61 weight percent, at least 62 weight percent, at least 63 weight percent, at least 64 weight percent, 65 weight percent, at least 66 weight percent, at least 67 weight percent, at least 68 weight percent, at least 69 weight percent, at least 70 weight percent, at least 71 weight percent, at least 72 weight percent, at least 73 weight percent, at least 74 weight percent, at least 75 weight percent, at least 76 weight percent, at least 77 weight percent, at least 78 weight percent, at least 79 weight percent, at least 80 weight percent, at least 81 weight percent, at least 82 weight percent, at least 83 weight percent, at least 84 weight percent, at least 85 weight percent, at least 86 weight percent, at least 87 weight percent, at least 88 weight percent, at least 89 weight percent, at least 90 weight percent, at least 91 weight percent, at least 92 weight percent, at least 93 weight percent, at least 94 weight percent, at least 95 weight percent, at least 96 weight percent, at least 97 weight percent, at least 98 weight percent, and at least 89 weight percent, based on the total weight of the polymer blend.

In certain embodiments, the amount of first polypropylene polymer in the polymer blend is less than 99 weight percent, less than 98 weight percent, less than 97 weight percent, less than 96 weight percent, less than 95 weight percent, less than 94 weight percent, less than 93 weight percent, less than 92 weight percent, less than 91 weight percent, less than 90 weight percent, less than 89 weight percent, less than 88 weight percent, less than 87 weight percent, less than 86 weight percent, less than 85 weight percent, less than 84 weight percent, less than 83 weight percent, less than 82 weight percent, less than 81 weight percent, less than 80 weight percent, less than 79 weight percent, less than 78 weight percent, less than 77 weight percent, less than 76 weight percent, less than 75 weight percent, less than 74 weight percent, less than 73 weight percent, less than 72 weight percent, less than 71 weight percent, less than 70 weight percent, less than 69 weight percent, less than 68 weight percent, less than 67 weight percent, and less than 66 weight percent, less than 65 weight percent, less than 64 weight percent, less than 63 weight percent, less than 62 weight percent, less than 61 weight percent, less than 60 weight percent, less than 59 weight percent, less than 58 weight percent, less than 57 weight percent, less than 56 weight percent, less than 55 weight percent, less than 54 weight percent, less than 53 weight percent, less than 52 weight percent, and less than 51 weight percent based on the total weight of the polymer blend.

It should also be recognized that polymer blends in accordance with embodiments of the present disclosure include ranges of the polypropylene polymer between any of the aforementioned weight percentages, such as from about 50 to 99 weight percent, 60 to 98 weight percent, 67 to 97 weight percent, 68 to 96 weight percent, 69 to 96 weight percent, 70 to 95 weight percent, 71 to 94 weight percent, 72 to 93 weight percent, 73 to 92 weight percent, 74 to 91 weight percent, and 75 to 90 weight percent, and variations of these ranges, based on the total weight of the polymer blend.

In certain embodiments, the first polypropylene polymer comprises a metallocene catalyzed polypropylene. In certain embodiments, the first polypropylene polymer comprises a Zeigler-Natta catalyzed polypropylene. In certain embodiments, the first polypropylene polymer resin comprises a blend of a metallocene catalyzed polypropylene and a Zeigler-Natta catalyzed polypropylene.

When present as a blend of a metallocene catalyzed polypropylene and a Zeigler-Natta catalyzed polypropylene, the ratio of the metallocene catalyzed polypropylene to the Zeigler-Natta catalyzed polypropylene is from about 5:95 to 95:5, and in particular, from about 10:90 to 90:10, and more particularly, from about 20:80 to 80:20. In preferred embodiments, the ratio of metallocene catalyzed polypropylene to the Zeigler-Natta catalyzed polypropylene is from about 15:85, and in particular, from about 25:75, and more particularly, from about 30:70, and even more particularly to 35:65.

In certain embodiments, the first polypropylene polymer comprises a blend of a metallocene catalyzed polypropylene and a Zeigler-Natta catalyzed polypropylene in which the Zeigler-Natta polypropylene comprises at least 50 weight percent of the polymer blend, based on the total weight of the blend. For instance, the amount of the Zeigler-Natta catalyzed polypropylene in the blend is at least about 50 weight percent, at least 52 weight percent, at least 54 weight percent, at least 56 weight percent, at least 58 weight percent, at least 60 weight percent, at least 60 weight percent, at least 52 weight percent, at least 64 weight percent, at least 66 weight percent, at least 68 weight percent, 70 weight percent, at least 72 weight percent, at least 74 weight percent, at least 76 weight percent, at least 78 weight percent, at least 80 weight percent, at least 82 weight percent, and at least 84 weight percent, based on the total weight of the polymer blend.

Suitable elastomeric polyolefins may include polymers having polyethylene, polypropylene, polybutylene, and other olefinic polymers, and blends thereof provided they have elastomeric properties, such as extensibility, flexibility, and the like. The elastomeric polyolefin polymer may include both polyolefin homopolymers and polyolefin copolymers, and blends thereof.

In certain embodiments, the elastomeric polyolefin polymer is present as a minor component in the polypropylene blend. In certain other embodiments, the elastomeric polyolefin polymer is present as the major component in the polymer blend.

The amount of the elastomeric polyolefin in the polymer blend is typically from 1 to 99 weight percent, based on the total weight of the fiber, and in particular, from about 5 to 95 weight percent, and more particularly, 10 to 90 weight percent, and even more particularly, from about 15 to 85 weight percent, based on the total weight of the polymer blend.

In certain embodiments, the amount of the elastomeric polyolefin in the polymer blend is typically from 1 to 30 weight percent, based on the total weight of the fiber, and in particular, from about 5 to 20 weight percent, based on the total weight of the fiber. More particularly, the amount of the elastomeric polyolefin in the blend is from about 1 to 25 weight percent, based on the total weight of the blend. In particular, the amount of the elastomeric polyolefin may be from about 2 to 20 weight percent, such as from about 4 to 16 weight percent, from about 5 to 15 weight percent, and from about 6 to 14 weight percent, based on the total weight of the blend.

In certain embodiments, the elastomeric polyolefin is present in the polymer blend in an amount ranging from about 2 to 30 weight percent, and in particular, 5 to 25 weight percent, and more particularly, from about 8 to 20 weight percent, based on the total weight of the polymer blend.

In certain embodiments of the invention, the elastomeric polyolefin has a molecular weight that is less than the molecular weight of the first polypropylene resin. For example, the molecular weight of the elastomeric polyolefin may be from about 5 to 35 percent less than the molecular weight of the first polypropylene resin, such as from about 10 to 25 percent less, and in particular, from about 15 to 20 percent less.

Suitable examples of elastomeric polyolefins may include polymers in which propylene represents the majority component of the polymeric backbone, and as a result, any residual crystallinity possesses the characteristics of polypropylene crystals. Residual crystalline entities embedded in the propylene-based elastomeric molecular network may function as physical crosslinks, providing polymeric chain anchoring capabilities that improve the mechanical properties of the elastic network, such as high recovery, low set and low force relaxation.

Suitable examples of elastomeric polyolefins may include an elastic random poly(propylene/olefin) copolymer, an isotactic polypropylene containing stereoerrors, an isotactic/atactic polypropylene block copolymer, an isotactic polypropylene/random poly(propylene/olefin) copolymer block copolymer, a stereoblock elastomeric polyolefin, a syndiotactic polypropylene block poly(ethylene-co-propylene) block syndiotactic polypropylene triblock copolymer, an isotactic polypropylene block regioirregular polypropylene block isotactic polypropylene triblock copolymer, a polyethylene random (ethylene/olefin) copolymer block copolymer, a reactor blend polypropylene, a very low density polypropylene (or, equivalently, ultra low density polypropylene), a metallocene polypropylene, and combinations thereof.

In some embodiments, the elastomeric polyolefins include polypropylenes having both hard and soft segments in which the hard segments are of high crystallinity and the soft segments are amorphous or semi-amorphous. For example, suitable elastomeric polyolefin polymers including crystalline isotactic blocks and amorphous atactic blocks are described, for example, in U.S. Pat. Nos. 6,559,262, 6,518,378, and 6,169,151.

In certain embodiments, the elastomeric polyolefins include elastomeric random copolymers (RCPs) including propylene with a low level comonomer (e.g., ethylene or a higher a-olefin) incorporated into the backbone. For example, the elastomeric polyolefin may comprise a propylene copolymer comprising at least two different types of monomer units, one of which is propylene. Suitable examples of monomer units include, for example, ethylene and higher α-olefins in the range of C₄ to C₂₀, such as 1-butene, 4-methyl-1-pentene, 1-hexene, or 1-octene. And 1-decene, or mixtures thereof. Preferably, ethylene is copolymerized with propylene, so that the propylene copolymer comprises propylene units (polymer chain units derived from propylene monomers) and ethylene units (polymer chain units derived from ethylene monomers).

Typically, the units or comonomers of the propylene copolymer are derived from ethylene or at least one of C4-10 alpha-olefins are from 1% to 35%, or from 5% to about 35% by weight of the propylene-alpha-olefin copolymer. It may be present in an amount of wt %, or 7 wt % to 32 wt %, or 8 to about 25 wt %, or 8 wt % to 20 wt %, or even 8 wt % to 18 wt %. The comonomer content is such that the propylene-α-olefin copolymer preferably has an isothermal heat of fusion (“DSC”) of 75000 Gy (75 J/g) or less, a melting point of 100° C. or less, and a crystallinity of 2% to about 65%. In certain embodiments, the polypropylene copolymer includes tactic polypropylene and can preferably be adjusted to have a melt flow rate of 0.5 to 90 dg/min.

In certain embodiments, the elastomeric polyolefin comprises a propylene-α-olefin copolymer having ethylene derived units. The propylene-α-olefin copolymer is 5% to 35%, or 5% to 20%, or 10% to 12%, or 15% to 20% by weight of the propylene-α-olefin copolymer. It may contain weight percent ethylene derived units. In some embodiments, the propylene-α-olefin copolymer consists essentially of units derived from propylene and ethylene, i.e, the propylene-α-olefin copolymer is ethylene and/or propylene used during polymerization.

In certain embodiments, the propylene-α-olefin copolymer may have a triad tacticity of three propylene units (measured by 13C NMR) of at least 75%, at least 80%, at least 82%, at least 85%, or at least 90% . . . “Triad tacticity” is determined as follows. The tacticity ratio (denoted herein as “m/r”) is determined by 13C nuclear magnetic resonance (“NMR”). The tacticity rate m/r N. Calculated by Cheng as defined in 17 MACROMOLECULES 1950 (1984), which is incorporated herein by reference. The notation “m” or “r” represents the stereochemistry of a pair of adjacent propylene groups, “m” refers to meso, and “r” refers to racemic. An m/r of 1.0 generally represents a syndiotactic polymer and an m/r ratio of 2.0 generally represents an atactic material. Isotactic materials theoretically have m/r ratios approaching infinity, and many byproduct atactic polymers have sufficient isotactic content to produce m/r ratios greater than 50.

Examples of suitable propylene-α-olefin copolymers may include VISTAMAXX® (ExxonMobil Chemical Company, Houston, Tex., USA), VERSIFY® (The Dow Chemical Company, Midland, Mich., USA).), Grades of TAFMER® XM or NOTIO® (Mitsui Company, Japan), and grades of SOFTEL® (Basell Polyfins of the Netherlands).

In certain embodiments, the elastomeric polyolefin comprises a low isotacticity homopolymer polypropylene (e.g., a polypropylene having an isotacticity [mmmm] from 30 to 70% by mol).

Accordingly, in certain embodiments the elastomeric polyolefin comprises a low isotacticity polypropylene that may be present in an amounts from about 1 to 30 weight percent, 2 to 245 weight percent, 3 to 22 weight percent, 4 to 21 weight percent, 5 to 20 weight percent, 6 to 19 weight percent, 7 to 18 weight percent, 8 to 17 weight percent, 9 to 16 weight percent, and 10 to 15 weight percent, based on the total weight of the polymer blend.

The low isotacticity polypropylene may generally be characterized by one or more of the following properties:
isotacticity: a meso pentad fraction [mmmm] of 20 to 70% by mol;
average number molecular weight (Mw) of 10,000 to 200,000;
a melting temperature from about 60 to 120° C.; and
a melt flow rate (MFR) greater than 40 g/10 min.

In addition to the above properties the low isotacticity polypropylene may have a B-viscosity from about 7,000 to 400,000 mPa, and a tensile modulus from about 80 to 120 MPa.

Low isotacticity polypropylenes polymers that are suitable generally have an isotacticity [mmmm] (% by mol) that is between about 20 and 70, and in particular, a [mmmm] between 30 and 60% by mol, and more particularly, a [mmmm] between 35 and 55% by mol. In one embodiment, the low isotacticity polypropylene has an isotacticity [mmmm] that is between about 40 and 50% by mol.

The stereochemistry (e.g., stereoregularity index ([mm]), meso pentad fraction [mmmm], the racemic pentad fraction [rrrr], the racemic-meso-racemic-meso pentad fraction [rmrm], and triad fractions [mm] [rr] and [mr]) of the low isotacticity polypropylene may be determined with an ¹³C-NMR spectrum according to the attribution of peaks proposed by A. Zambelli, et al., Macromolecules, No. 8, p. 687 (1975). A ¹³C-NMR, Model JNM-EX400, produced by JEOL Ltd. may be used to obtain the spectrum according to the following parameters:
Method: proton complete decoupling method;
Concentration: 220 mg/mL;
Solvent: mixed solvent of 1,2,4-trichlorobenzene and deuterated benzene (90/10 by volume);
Temperature: 130° C.;
Pulse width: 45°;
Pulse repetition time: 4 sec;
Accumulation: 10,000 times;

$$\begin{matrix}M = m / S \times 100 \\ R = γ / S \times 100 \\ S = P ββ + P α β + P αγ \\ S = P ββ : 19.8 - 22.5 ppm\end{matrix} \qquad 〈 Calculation Expression 〉$$

Pαβ: 18.0-17.5 ppm
Pαγ: 17.5-17.1 ppm
γ: racemic pentad chain: 20.7-20.3 ppm
m: meso pentad chain: 21.7-22.5 ppm.

In certain embodiments, the elastomeric polyolefin comprises a low isotactic polypropylene having an isotacticity [mmmm] (% by mol) that is greater than about 30, greater than about 31, greater than about 32, greater than about 33, greater than about 34, greater than about 35, greater than about 36, greater than about 37 greater than about 38, greater than about 39, greater than about 40, greater than about 41, greater than about 42, greater than about 43, greater than about 44, greater than about 45, greater than about 45, greater than about 47, greater than about 48, greater than about 49, greater than about 50, greater than about 51, greater than about 52, greater than about 53, greater than about 54, greater than about 55, greater than about 56, greater than about 57, greater than about 58, greater than about 59, and greater than about 60.

In one embodiment, the low isotacticity polypropylene has an isotacticity [mmmm] (% by mol) that is less than about 60, less than about 59, less than about 58, less than about 57, less than about 56, less than about 55, less than about 54, less than about 53, less than about 52, less than about 51, less than about 50, less than about 49, less than about 48, less than about 47, less than about 46, less than about 45, less than about 44, less than about 43, less than about 42, less than about 41, less than about 40, less than about 39, less than about 38, less than about 37, less than about 36, less than about 35, less than about 34, less than about 33, less than about 32, and less than about 31.

In some embodiments, the elastomeric polyolefin comprises a low isotacticity polypropylene may have a crystallinity that is from about 30 to 60 percent, such as between 35 and 55 percent, between 40, and 50 percent, and preferably, between 42 and 48 percent. In one embodiment, the low isotacticity polypropylene may have a crystallinity that is from about 44 to 46 percent. Crystallinity of the low isotacticity polypropylene may be measured in accordance with ASTM D-3418-15.

In one embodiment, the elastomeric polyolefin comprises a low isotacticity polypropylene typically having an MFR greater than 40 g/10 min and a molecular weight of less than 140,000 g/mol, and in particular, an MFR greater than 45 g/10 min and a molecular weight less than 134,200 g/mol. In a preferred embodiment, the elastomeric polyolefin comprises a low isotacticity polypropylene having a molecular weight between 124,200 g/mol and 134,200 g/mol and an MFR from about 45 to 55 g/10 min. Unless otherwise indicated MFR is measured in accordance with ASTM D-1238.

In certain embodiments, the elastomeric polyolefin comprises a low isotacticity polypropylene having a melting temperature that is greater than about 60° C., and in particular, from about 60 to 120° C., and more particularly, from about 60 to 100° C. In one embodiment, the low isotacticity polypropylene has a melting temperature that is from about 65 to 85° C., and in particular, from about 70 to 80° C. The melting temperature of low isotacticity polypropylene can be determined in accordance with ISO 306 Method A50.

In certain embodiments, the elastomeric polyolefin comprises a low tacticity polypropylene having a molecular weight ranging from about 30,000 to about 150,000 g/mol, and in particular, from about 44,200 to about 140,000 g/mol, and more particularly, from about 70,000 to 134,200 g/mol. In a preferred embodiment, the low isotacticity polypropylene has a molecular weight that is from about 128,000 to about 132,000 g/mol.

In one embodiment, the elastomeric polyolefin comprises a low isotacticity polypropylene may have a molecular weight less than one of the following: less than about 150,000 g/mol, less than about 144,200 g/mol, less than about 140,000 g/mol, less than about 138,000 g/mol, less than about 136,000 g/mol, less than about 134,000 g/mol, less than about 132,000 g/mol, less than about 130,000 g/mol, less than about 128,000 g/mol, less than about 126,000 g/mol, less than about 124,000 g/mol, less than about 122,000 g/mol, less than about 120,000 g/mol, less than about 118,000 g/mol, less than about 116,000 g/mol, less than about 114,000 g/mol, less than about 112,000 g/mol, less than about 110,000 g/mol, less than about 108,000 g/mol, less than about 106,000 g/mol, less than about 104,000 g/mol, less than about 102,000 g/mol, less than about 100,000 g/mol, less than about 98,000 g/mol, less than about 96,000 g/mol, less than about 94,000 g/mol, less than about 92,000 g/mol, less than about 90,000 g/mol, less than about 88,000 g/mol, less than about 86,000 g/mol, less than about 84,000 g/mol, less than about 82,000 g/mol, less than about 80,000 g/mol, less than about 78,000 g/mol, less than about 76,000 g/mol, less than about 74,000 g/mol, less than about 72,000 g/mol, or less than about 70,000 g/mol.

In some embodiments, the low isotacticity polypropylene has a molecular weight that is less than the molecular weight of the first polypropylene polymer resin in which it is blended. For example, in certain embodiments of the present invention, the percent difference in the molecular weight between the first polypropylene polymer and the low isotacticity polypropylene is from 5 to 150%. In one embodiment, the percent difference may be between 7 and 120%. In a preferred embodiment, the percent difference in the molecular weight between the first polypropylene polymer and the low isotacticity polypropylene is from about 20 to 35%, and more preferably, from about 25 to 30%.

In the context of the present invention, percent difference is calculated according to the following:

$$PERCENT DIFFERENCE = \frac{\vert {V}_{1} - {V}_{2} \vert}{[ \frac{( {V}_{1} + {V}_{2} )}{2} ]} \times 100$$

In one embodiment, the polypropylene polymer has a molecular weight of 172,000 g/mol and the low isotacticity weight polypropylene has a molecular weight that is about 130,000 to provide a percent difference of about 27.8%. In another embodiment, the first polypropylene may have a molecular weight of about 140,000 g/mol, and the low isotacticity polypropylene may have a molecular weight of 130,000 g/mol to provide a percent difference of about 7%. In a further embodiment, the first polypropylene may have a molecular weight of about 172,000 g/mol, and the low isotacticity polypropylene may have a molecular weight of 44,200 to provide a percent difference of about 117%

Examples of suitable low isotacticity polypropylenes are available from Idemitsu under the product name L-MODU™. Examples include S400 (˜2,600 MFR g/10 min, density of 0.87 g/cm³, and Mw 45 k g/mol); S600 (390 MFR g/10 min, density of 0.87 g/cm³, and Mw 75 k g/mol); and S901 (50 MFR g/10 min, density of 0.87 g/cm³, and Mw 130 k g/mol).

In other embodiments, the low isotacticity polypropylene may comprise a copolymer of ethylene and propylene units.

In a preferred embodiment, the thermoplastic fibers comprise a blend of a polypropylene resin and an elastomeric polyolefin in which the polypropylene resin has a molecular weight ranging from any of 120,000 to 300,000 g/mol, a melting temperature from about 150° C. to about 175° C., and wherein the polypropylene resin comprises a Ziegler-Natta catalyzed polypropylene, a metallocene catalyzed polypropylene, or a blend thereof. In certain preferred embodiments, the elastomeric polypropylene is present in the polymer blend in an amount ranging from about 2 to 30 weight percent, based on the total weight of the polymer blend, and the elastomeric polyolefin is selected from the group consisting of a propylene-alpha-olefin copolymer and a low isotacticity polypropylene polymer.

### Bio-Based and Biodegradable Polymers

In some embodiments, the polymers may comprise polymers derived from mechanically or chemically recycled feedstocks. For example, up to 100% of the polymer comprising the nonwoven fabric may be derived from recycled polymers.

In further embodiments, the thermoplastic fibers of the absorbent layer in accordance with one or more embodiments of the invention may be prepared from bio-based materials, and in particular, from bio-based polymers. In contrast to polymers derived from petroleum sources, bio-based polymers are generally derived from a bio-based material. In some embodiments, a bio-based polymer may also be considered biodegradeable. A special class of biodegradable product made with a bio-based material might be considered as compostable if it can be degraded in a composting environment. The European standard EN 13432, “Proof of Compostability of Plastic Products” may be used to determine if a fabric or film comprised of sustainable content could be classified as compostable.

In one such embodiment, the thermoplastic fibers comprise a bio-based polymer. In certain embodiments, the thermoplastic fibers are substantially free of synthetic materials, such as petroleum-based materials and polymers. For example, fibers comprising the nonwoven fabric may have less than 25 weight percent of materials that are non-bio-based, and more preferably, less than 20 weight percent, less than 15 weight percent, less than 10 weight percent, and even more preferably, less than 5 weight percent of non-bio-based materials, based on the total weight of the nonwoven fabric.

In certain embodiments, the thermoplastic fibers comprise a bio-based polymer and a polymer derived from a petroleum source.

In certain embodiments, bio-based polymers for use may include aliphatic polyester based polymers, such as polylactic acid, and bio-based derived polyethylene.

Aliphatic polyesters useful in the preparation of the thermoplastic fibers may include homo- and copolymers of poly(hydroxyalkanoates), and homo- and copolymers of those aliphatic polyesters derived from the reaction product of one or more polyols with one or more polycarboxylic acids that are typically formed from the reaction product of one or more alkanediols with one or more alkanedicarboxylic acids (or acyl derivatives). Polyesters may further be derived from multifunctional polyols, e.g. glycerin, sorbitol, pentaerythritol, and combinations thereof, to form branched, star, and graft homo- and copolymers. Polyhydroxyalkanoates generally are formed from hydroxyacid monomeric units or derivatives thereof. These include, for example, polylactic acid, polyhydroxybutyrate, polyhydroxyvalerate, polycaprolactone and the like. Miscible and immiscible blends of aliphatic polyesters with one or more additional semicrystalline or amorphous polymers may also be used.

One useful class of aliphatic polyesters are poly(hydroxyalkanoates), derived by condensation or ring-opening polymerization of hydroxy acids, or derivatives thereof. Suitable poly(hydroxyalkanoates) may be represented by the formula: H(O—R—C(O)—)ₙOH where R is an alkylene moiety that may be linear or branched having 1 to 20 carbon atoms, preferably 1 to 12 carbon atoms optionally substituted by catenary (bonded to carbon atoms in a carbon chain) oxygen atoms; n is a number such that the ester is polymeric, and is preferably a number such that the molecular weight of the aliphatic polyester is at least 10,000, preferably at least 30,000, and most preferably at least 50,000 daltons. In certain embodiments, the molecular weight of the aliphatic polyester is typically less than 1,000,000, preferably less than 500,000, and most preferably less than 300,000 daltons. R may further comprise one or more caternary (i.e. in chain) ether oxygen atoms. Generally, the R group of the hydroxy acid is such that the pendant hydroxyl group is a primary or secondary hydroxyl group.

Useful poly(hydroxyalkanoates) include, for example, homo- and copolymers of poly(3-hydroxybutyrate), poly(4-hydroxybutyrate), poly(3-hydroxyvalerate), poly(lactic acid) (as known as polylactide), poly(3-hydroxypropanoate), poly(4-hydropentanoate), poly(3-hydroxypentanoate), poly(3-hydroxyhexanoate), poly(3-hydroxyheptanoate), poly(3-hydroxyoctanoate), polydioxanone, polycaprolactone, and polyglycolic acid (i.e. polyglycolide). Copolymers of two or more of the above hydroxy acids may also be used, for example, poly(3-hydroxybutyrate-co-3-hydroxyvalerate), poly(lactate-co-3-hydroxypropanoate), poly(glycolide-co-p-dioxanone), and poly(lactic acid-co-glycolic acid). Blends of two or more of the poly(hydroxyalkanoates) may also be used, as well as blends with one or more semicrystalline or amorphous polymers and/or copolymers.

The aliphatic polyester may be a block copolymer of poly(lactic acid-co-glycolic acid). Aliphatic polyesters useful in the inventive compositions may include homopolymers, random copolymers, block copolymers, star-branched random copolymers, star-branched block copolymers, dendritic copolymers, hyperbranched copolymers, graft copolymers, and combinations thereof.

Another useful class of aliphatic polyesters includes those aliphatic polyesters derived from the reaction product of one or more alkanediols with one or more alkanedicarboxylic acids (or acyl derivatives). Such polyesters have the general formula:

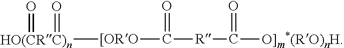

where R′ and R″ each represent an alkylene moiety that may be linear or branched having from 1 to 20 carbon atoms, preferably 1 to 12 carbon atoms, and m is a number such that the ester is polymeric, and is preferably a number such that the molecular weight of the aliphatic polyester is at least 10,000, preferably at least 30,000, and most preferably at least 50,000 daltons, but less than 1,000,000, preferably less than 500,000 and most preferably less than 300,000 daltons. Each n is independently 0 or 1. R′ and R″ may further comprise one or more caternary (i.e. in chain) ether oxygen atoms.

Examples of aliphatic polyesters include those homo- and copolymers derived from (a) one or more of the following diacids (or derivative thereof): succinic acid; adipic acid; 1,12 dicarboxydodecane; fumaric acid; glutartic acid; diglycolic acid; and maleic acid; and (b) one of more of the following diols: ethylene glycol; polyethylene glycol; 1,2-propane diol; 1,3-propanediol; 1,2-propanediol; 1,2-butanediol; 1,3-butanediol; 1,4-butanediol; 2,3-butanediol; 1,6-hexanediol; 1,2 alkane diols having 5 to 12 carbon atoms; diethylene glycol; polyethylene glycols having a molecular weight of 300 to 10,000 daltons, and preferably 400 to 8,000 daltons; propylene glycols having a molecular weight of 300 to 4000 daltons; block or random copolymers derived from ethylene oxide, propylene oxide, or butylene oxide; dipropylene glycol; and polypropylene glycol, and (c) optionally a small amount, i.e., 0.5-7.0 mole percent of a polyol with a functionality greater than two, such as glycerol, neopentyl glycol, and pentaerythritol.

Such polymers may include polybutylene succinate homopolymer, polybutylene adipate homopolymer, polybutyleneadipate-succinate copolymer, polyethylenesuccinate-adipate copolymer, polyethylene glycol succinate homopolymer and polyethylene adipate homopolymer.

Commercially available aliphatic polyesters include poly(lactide), poly(glycolide), poly(lactide-co-glycolide), poly(L-lactide-co-trimethylene carbonate), poly(dioxanone), poly(butylene succinate), and poly(butylene adipate).

The term “aliphatic polyester” covers—besides polyesters which are made from aliphatic and/or cycloaliphatic components exclusively also polyesters which contain besides aliphatic and/or cycloaliphatic units, aromatic units, as long as the polyester has substantial bio-based content.

In addition to PLA based resins, nonwoven fabrics in accordance with embodiments of the invention may include other polymers derived from an aliphatic component possessing one carboxylic acid group and one hydroxyl group, which are alternatively called polyhydroxyalkanoates (PHA). Examples thereof are polyhydroxybutyrate (PHB), poly-(hydroxybutyrate-co-hydroxyvaleterate) (PHBV), poly-(hydroxybutyrate-co-polyhydroxyhexanoate) (PHBH), polyglycolic acid (PGA), poly-(epsilon-caprolactione) (PCL) and preferably polylactic acid (PLA).

Examples of additional polymers that may be used in preparation of the thermoplastic fibers include polymers derived from a combination of an aliphatic component possessing two carboxylic acid groups with an aliphatic component possessing two hydroxyl groups, and are polyesters derived from aliphatic diols and from aliphatic dicarboxylic acids, such as polybutylene succinate (PBS), polyethylene succinate (PES), polybutylene adipate (PBA), polyethylene adipate (PEA), polytetramethy-lene adipate/terephthalate (PTMAT).

Useful aliphatic polyesters include those derived from semicrystalline polylactic acid. Poly(lactic acid) or polylactide (PLA) has lactic acid as its principle degradation product, which is commonly found in nature, is non-toxic and is widely used in the food, pharmaceutical and medical industries. The polymer may be prepared by ring-opening polymerization of the lactic acid dimer, lactide. Lactic acid is optically active and the dimer appears in four different forms: L,L-lactide, D,D-lactide, D,L-lactide (meso lactide) and a racemic mixture of L,L- and D,D-. By polymerizing these lactides as pure compounds or as blends, poly(lactide) polymers may be obtained having different stereochemistries and different physical properties, including crystallinity. The L,L- or D,D-lactide yields semicrystalline poly(lactide), while the poly(lactide) derived from the D,L-lactide is amorphous.

Generally, polylactic acid based polymers are prepared from dextrose, a source of sugar, derived from field corn. In North America corn is used since it is the most economical source of plant starch for ultimate conversion to sugar. However, it should be recognized that dextrose can be derived from sources other than corn. Sugar is converted to lactic acid or a lactic acid derivative via fermentation through the use of microorganisms. Lactic acid may then be polymerized to form PLA. In addition to corn, other agriculturally-based sugar sources may be used including rice, sugar beets, sugar cane, wheat, cellulosic materials, such as xylose recovered from wood pulping, and the like.

The polylactide preferably has a high enantiomeric ratio to maximize the intrinsic crystallinity of the polymer. The degree of crystallinity of a poly(lactic acid) is based on the regularity of the polymer backbone and the ability to crystallize with other polymer chains. If relatively small amounts of one enantiomer (such as D-) is copolymerized with the opposite enantiomer (such as L-) the polymer chain becomes irregularly shaped, and becomes less crystalline. For these reasons, when crystallinity is favored, it is desirable to have a poly(lactic acid) that is at least 85% of one isomer, at least 90% of one isomer, or at least 95% of one isomer in order to maximize the crystallinity.

In some embodiments, an approximately equimolar blend of D-polylactide and L-polylactide is also useful. In certain embodiments, this blend forms a unique crystal structure having a higher melting point than does either the D-poly(lactide) and L-(polylactide) alone, and has improved thermal stability.

Copolymers, including block and random copolymers, of poly(lactic acid) with other aliphatic polyesters may also be used. Useful co-monomers include glycolide, beta-propiolactone, tetramethylglycolide, beta-butyrolactone, gamma-butyrolactone, pivalolactone, 2-hydroxybutyric acid, alpha-hydroxyisobutyric acid, alpha-hydroxyvaleric acid, alpha-hydroxyisovaleric acid, alpha-hydroxycaproic acid, alpha-hydroxyethylbutyric acid, alpha-hydroxyisocaproic acid, alpha-hydroxy-beta-methylvaleric acid, alpha-hydroxyoctanoic acid, alpha-hydroxydecanoic acid, alpha-hydroxymyristic acid, and alpha-hydroxystearic acid.

Blends of poly(lactic acid) and one or more other aliphatic polyesters, or one or more other polymers may also be used. Examples of useful blends include poly(lactic acid) and poly(vinyl alcohol), polyethylene glycol/polysuccinate, polyethylene oxide, polycaprolactone and polyglycolide.

In certain preferred embodiments, the aliphatic polyester component comprises a PLA based resin. A wide variety of different PLA resins may be used to prepare nonwoven fabrics in accordance with embodiments of the invention. The PLA resin should have proper molecular properties to be spun in spunbond processes. Examples of suitable include PLA resins are supplied from NatureWorks LLC, of Minnetonka, Minn. 55345 such as, grade 6752D, 6100D, and 6202D, which are believed to be produced as generally following the teaching of U.S. Pat. Nos. 5,525,706 and 6,807,973 both to Gruber et al. Other examples of suitable PLA resins may include L130, L175, and LX175, all from Corbion of Arkelsedijk 46, 4206 A C Gorinchem, the Netherlands.

In some embodiments, the thermoplastic fibers of the absorbent layer may comprise bio-based polymer components of biodegradable products that are derived from an aliphatic component possessing one carboxylic acid group (or a polyester forming derivative thereof, such as an ester group) and one hydroxyl group (or a polyester forming derivative thereof, such as an ether group) or may be derived from a combination of an aliphatic component possessing two carboxylic acid groups (or a polyester forming derivative thereof, such as an ester group) with an aliphatic component possessing two hydroxyl groups (or a polyester forming derivative thereof, such as an ether group).

Additional nonlimiting examples of bio-based polymers include polymers directly produced from organisms, such as polyhydroxyalkanoates (e.g., poly(beta-hydroxyalkanoate), poly(3-hydroxybutyrate-co-3-hydroxyvalerate, NODAX™), and bacterial cellulose; polymers extracted from plants and biomass, such as polysaccharides and derivatives thereof (e.g., gums, cellulose, cellulose esters, chitin, chitosan, starch, chemically modified starch), proteins (e.g., zein, whey, gluten, collagen), lipids, lignins, and natural rubber; and current polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

In some embodiments, the bio-based polymer may comprise bio-based polyethylene, bio-based polypropylene, and bio-based polyesters, such as bio-based PET, that are derived from a biological source. For example, bio-based polyethylene can be prepared from sugars that are fermented to produce ethanol, which in turn is dehydrated to provide ethylene. An example of a suitable sugar cane derived polyethylene is available from Braskem S.A. under the product name PE SHA7260.

In some embodiments, the thermoplastic fibers of the absorbent layer may include one or more additional additives that are blended with the polymer(s) during the melt extrusion phase. Examples of suitable additives include one or more of colorants, such as pigments (e.g., TiO₂), UV stabilizers, hydrophobic agents, hydrophilic agents, antistatic agent, elastomers, compatibilizers, antioxidants, anti-block agent, slip agents, surfactants, optical brighteners, flame retardants, antimicrobials, such as copper oxide and zinc oxide and the like.

In certain embodiments, one or more surfaces of the multilayer absorbent composite are coated with a liquid coating comprising super absorbent material that adheres to the surfaces of the individual fibers of the absorbent layer and the cohesive layer. The super absorbent material forms a three-dimensional structure within the multilayer absorbent composite that is permanently affixed to the nonwoven/film structure, fluid permeable, and highly absorbent. The liquid coating may be applied with a kiss roller, spray on application, or the like.

### Properties of the Multilayer Absorbent Composite

In accordance with certain embodiments, for example, the multilayer absorbent composite may have a basis weight from about 30 grams per square meter (gsm) to about 100 gsm, depending on the number of layers in the composite and the composition of each layer.

In particular, the multilayer absorbent composite may have a basis weight from about 40 gsm to about 90 gsm. In certain embodiments, for example, the multilayer absorbent composite may comprise a basis weight from about 45 gsm to about 80 gsm. In further embodiments, for instance, the multilayer absorbent composite may have a basis weight from about 48 gsm to about 72 gsm. In one embodiment, the multilayer absorbent composite may have a basis weight from about 55 gsm to about 265 gsm. As such, in certain embodiments, the fabric may have a basis weight from at least about any of the following: 40, 42, 44, 46, 48, 50, 52, 54, 56, 58, 60, 62, 64, 66, 68, 70, 72, and 74 gsm and/or at most about 100, 98, 96, 94, 92, 90, 88, 86, 84, 82, 80, 78, 76, 74, 72, 70, 68, 66, 64, 62, and 60 gsm (e.g., about 40-100 gsm, about 48-80 gsm, about 56 to 64 gsm, etc.).

The thickness (caliper) of the multilayer absorbent composite may range from about 0.5 to 1.5 mm, and in particular, from about 0.70 to 1.25 mm, and more particularly from about 0.75 to 1.1 mm.

In certain embodiments, multilayer absorbent composites in accordance with embodiments of the invention may exhibit a dry and/or wet (collectively “dry/wet”) machine direction tensile strength (MDT) ranging from about 10 to 65 N/5 cm, particular, from about 18 to 60 N/5 cm, and in particular, from about 30 to 45 N/5 cm, and more particularly, from about 35 to 40 N/5 cm.

In certain embodiments, the multilayer absorbent composite exhibits a dry and/or wet MDT of at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 51, at least 52, at least 53, at least 54, at least 55, at least 56, at least 57, at least 58, at least 59, and at least 60 N/5 cm.

In certain embodiments, the multilayer absorbent composite exhibits a dry and/or wet MDT less than 60, less than 59, less than 58, less than 57, less than, 56, less than 55, less than 54, less than 53, less than 52, less than 51, less than 50, less than, 49, less than 48, less than 47, less than 46, less than 45, less than 44, less than 43, less than 42, less than 41, less than 40, less than 39, less than 38, less than 37, less than 36, less than 35, less than 34, less than 33, less than 32, less than 31, less than 30, less than 29, less than 28, less than 27, less than 26, and less than 25 N/5/cm.

In certain embodiments, multilayer absorbent composites in accordance with embodiments of the invention may exhibit a dry and/or wet machine direction elongation (MDE) ranging from about 20 to 100, and in particular, from about 30 to 100%, such as from about 35 to 75%, and more particularly, from about 50 to 75%.

In certain embodiments, the multilayer absorbent composite exhibits a dry and/or wet MDE of at least 30, at least 32, at least 34, at least 36, at least 38, at least 40, at least 42, at least 44, at least 46, at least 48, at least 50, at least 52, at least 54, at least 56, at least 58, at least 60, at least 62, at least 64, at least 66, at least 68, at least 70, at least 72, at least 74, at least 76, at least 78, at least 80, at least 82, at least 84, at least 86, at least 88, at least 90, at least 92, at least 94, at least 96, at least 98, and at least 100%.

In certain embodiments, the multilayer absorbent composite exhibits a dry and/or wet MDE less than 100, less than 98, less than 96, less than 94, less than 92, less than 90, less than 88, less than 86, less than 84, less than 82, less than 80, less than 78, less than 76, less than 74, less than 72, less than 70, less than 68, less than 66, less than 64, less than 62, less than 60, less than 58, less than 56, less than 54, less than 52, less than 50, less than 48, less than 46, less than 44, less than 42, less than 40, less than 38, less than 36, less than 34, less than 32, and less than 30%.

In certain embodiments, multilayer absorbent composites in accordance with embodiments of the invention may exhibit a dry and/or wet cross direction tensile strength (CDT) ranging from about 6 to 30 N/5 cm or 10 to 25 N/5 cm, and in particular, from about 12 to 20 N/5 cm, and more particularly, from about 14 to 18 N/5 cm.

In certain embodiments, the multilayer absorbent composite exhibits a dry and/or wet CDT of at least 10, at least 11, at least 12, at least 13, at least 14, at least 15, at least 16, at least 17, at least 18, at least 19, at least 20, at least 21, at least 22, at least 23, at least 24, and at least 25 N/5 cm.

In certain embodiments, the multilayer absorbent composite exhibits a dry and/or wet CDT less than 25, less than 24, less than 23, less than 22, less than 21, less than 20, less than 19, less than 18, less than 17, less than 16, less than 15, less than 14, less than 13, less than 12, less than 11, and less than 10 N/5/cm.

In certain embodiments, multilayer absorbent composites in accordance with embodiments of the invention may exhibit a dry and/or wet cross direction elongation (CDE) ranging from about 40 to 120%, and in particular, from about 55 to 85%, and more particularly, from about 60 to 80%.

In certain embodiments, the multilayer absorbent composite exhibits a dry and/or wet CDE of at least 40, of at least 45, at least 50, at least 55, at least 60, at least 62, at least 64, at least 66, at least 68, at least 70, at least 72, at least 74, at least 76, at least 78, at least 80, at least 82, at least 84, at least 86, at least 88, at least 90, at least 92, at least 94, at least 96, at least 98, and at least 100%.

In certain embodiments, the multilayer absorbent composite exhibits a dry and/or wet MDE less than 100, less than 98, less than 96, less than 94, less than 92, less than 90, less than 88, less than 86, less than 84, less than 82, less than 80, less than 78, less than 76, less than 74, less than 72, less than 70, less than 68, less than 66, less than 64, less than 62, and less than 60.

In certain embodiments, multilayer absorbent composites in accordance with embodiments of the invention may exhibit improvements in one or more of dry/wet machine direction tensile strengths (MDT), dry/wet machine direction elongations (MDE), dry/wet cross direction tensile strengths (CDT) cross direction elongations (CDE) in comparison to a similar or identical fabric that does not include the cohesive layer. More specifically, in comparison to a comparative absorbent layer that is similarly prepared comprising the same blend of thermoplastic fibers and solid additives (e.g., pulp fibers) and at the same overall basis weight that does not include the cohesive layer.

In certain embodiments, the similarly prepared absorbent layer is substantially identical (for example same polymer chemistry and solid additive composition with the exception of the presence of the cohesive layer) to the inventive multilayer absorbent composite. Some variations in process conditions used in the similarly prepared nonwoven fabric may exist, such as, for example, slight variations in calender temperatures and pressures.

In certain embodiments of the disclosure, multilayer absorbent composites in accordance with aspects of the disclosure are characterized by one or more of an increase in dry/wet MDT of at least 200%, at least 205%, at least 210%, at least 215%, at least 220%, at least 230%, at least 235%, at least 240%, at least 245%, at least 250%, at least 255%, at least 260%, at least 265% at least 270%, at least 275%, at least 280%, at least 285%, at least 290%, at least 295%, and at least 300% in comparison to an identically/similarly prepared nonwoven fabric that does not include the cohesive layer.

In certain embodiments, multilayer absorbent composites in accordance with aspects of the disclosure are characterized by exhibiting an increase in dry/wet MDT ranging from about 225 to 300%, and in particular, from about 250 to 280% in comparison to an identically/similarly prepared nonwoven fabric that does not include the cohesive layer.

In certain embodiments of the disclosure, multilayer absorbent composites in accordance with aspects of the disclosure are characterized by one or more of an increase in dry/wet MDE of at least 75%, at least 80%, at least 85%, at least 90%, at least 95%, at least 100%, at least 105%, at least 110%, at least 115%, at least 120%, at least 125%, at least 130%, at least 135% at least 140%, at least 145%, at least 150%, at least 155%, at least 160%, at least 165%, at least 170%, at least 175%, and at least 180% in comparison to an identically/similarly prepared nonwoven fabric that does not include the cohesive layer.

In certain embodiments, multilayer absorbent composites in accordance with aspects of the disclosure are characterized by exhibiting an increase in dry/wet MDE ranging from about 75 to 180%, and in particular, from about 100 to 150% in comparison to an identically/similarly prepared nonwoven fabric that does not include the cohesive layer.

In certain embodiments of the disclosure, multilayer absorbent composites in accordance with aspects of the disclosure are characterized by one or more of an increase in dry/wet CDT of at least 50%, at least 60%, at least 70%, at least 80%, at least 90%, at least 100%, at least 110%, at least 120%, at least 130%, at least 140%, at least 150%, at least 160%, at least 170% at least 180%, at least 190%, and at least 200% in comparison to an identically/similarly prepared nonwoven fabric that does not include the cohesive layer.

In certain embodiments, multilayer absorbent composites in accordance with aspects of the disclosure are characterized by exhibiting an increase in dry/wet CDT ranging from about 20 to 200%, and in particular, from about 70 to 175% in comparison to an identically/similarly prepared nonwoven fabric that does not include the cohesive layer.

In certain embodiments of the disclosure, multilayer absorbent composites in accordance with aspects of the disclosure are characterized by one or more of an increase in dry/wet CDE of at least 20%, at least 25%, at least 30%, at least 35%, at least 40%, at least 45%, at least 50%, at least 55%, at least 60%, at least 65%, at least 70%, at least 75%, and at least 80% in comparison to an identically/similarly prepared nonwoven fabric that does not include the cohesive layer.

In certain embodiments, multilayer absorbent composites in accordance with aspects of the disclosure are characterized by exhibiting an increase in dry/wet CDE ranging from about 20 to 75%, and in particular, from about 25 to 60% in comparison to an identically/similarly prepared nonwoven fabric that does not include the cohesive layer.

Advantageously, multilayer absorbent composites in accordance with aspects of the disclosure are also characterized by improvements in wet Mullen Burst strength. The Mullen Burst strength of a material is indicative as to how well the material will resist and/or prevent the formation of tears, punctures, rips, holes and the like in the material.

In certain embodiments, multilayer absorbent composites exhibit a dry/wet Mullen Burst strength greater than 10 psi, such as a Mullen Burst Strength ranging from about 16 to 24 psi, and in particular, from about 17 to 20 psi, and more particularly, from about 18 to 19 psi.

In certain embodiments, multilayer absorbent composites in accordance with aspects of the disclosure are characterized by exhibiting an increase in dry/wet mullen burst strength of at least 10%, at least 12%, at least 16%, at least 18%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 105%, at least 110%, at least 115%, at least 120%, and at least 125% in comparison to an identically/similarly prepared nonwoven fabric that does not include the cohesive layer.

In certain embodiments, multilayer absorbent composites in accordance with aspects of the disclosure are characterized by exhibiting an increase in dry/wet Mullen Burst Strength ranging from about 25 to 125%, and in particular, from about 30 to 100% in comparison to an identically/similarly prepared nonwoven fabric that does not include the cohesive layer.

In certain embodiments, multilayer absorbent composites in accordance with embodiments of the disclosure exhibit two or more of the following properties:
i) a dry/wet machine direction tensile strength (MDT) ranging from about 25 to 60 N/5 cm, and in particular, from about 30 to 45 N/5 cm, and more particularly, from about 35 to 40 N/5 cm;
ii) a dry/wet machine direction elongation (MDE) ranging from about 30 to 100%, and in particular, from about 35 to 75%, and more particularly, from about 50 to 75%;
iii) exhibit a dry/wet cross direction tensile strength (CDT) ranging from about 10 to 25 N/5 cm, and in particular, from about 12 to 20 N/5 cm, and more particularly, from about 14 to 18 N/5 cm;
iv) a dry/wet cross direction elongation (CDE) ranging from about 60 to 100%, and in particular, from about 62 to 85%, and more particularly, from about 70 to 80%; and
v) a dry/wet Mullen Burst strength ranging from about 16 to 24 psi, and in particular, from about 17 to 20 psi, and more particularly, from about 18 to 19 psi.

In certain preferred embodiments, multilayer absorbent composites in accordance with aspects of the disclosure are characterized by two or more of the following:
i) an increase in dry/wet MDT ranging from about 225 to 300%, and in particular, from about 250 to 280% in comparison to an identically/similarly prepared nonwoven fabric that does not include the cohesive layer;
ii) an increase in dry/wet MDE ranging from about 75 to 180%, and in particular, from about 100 to 150% in comparison to an identically/similarly prepared nonwoven fabric that does not include the cohesive layer;
iii) an increase in dry/wet CDT ranging from about 20 to 200%, and in particular, from about 70 to 175% in comparison to an identically/similarly prepared nonwoven fabric that does not include the cohesive layer;
iv) an increase in dry/wet CDE ranging from about 20 to 75%, and in particular, from about 25 to 60% in comparison to an identically/similarly prepared nonwoven fabric that does not include the cohesive layer; and
V) an increase in dry/wet Mullen Burst Strength ranging from about 25 to 125%, and in particular, from about 30 to 100% in comparison to an identically/similarly prepared nonwoven fabric that does not include the cohesive layer.

In certain preferred embodiments, multilayer absorbent composites in accordance with aspects of the disclosure are characterized by two or more of the following:
i) a dry/wet machine direction tensile strength (MDT) ranging from about 25 to 60 N/5 cm, and in particular, from about 30 to 45 N/5 cm, and more particularly, from about 35 to 40 N/5 cm;
ii) a dry/wet machine direction elongation (MDE) ranging from about 30 to 100%, and in particular, from about 35 to 75%, and more particularly, from about 50 to 75%;
iii) exhibit a dry/wet cross direction tensile strength (CDT) ranging from about 10 to 25 N/5 cm, and in particular, from about 12 to 20 N/5 cm, and more particularly, from about 14 to 18 N/5 cm;
iv) a dry/wet cross direction elongation (CDE) ranging from about 60 to 100%, and in particular, from about 62 to 85%, and more particularly, from about 70 to 80%;
v) a dry/wet Mullen Burst strength ranging from about 16 to 24 psi, and in particular, from about 17 to 20 psi, and more particularly, from about 18 to 19 psi;
vi) increase in dry/wet MDT ranging from about 225 to 300%, and in particular, from about 250 to 280% in comparison to an identically/similarly prepared nonwoven fabric that does not include the cohesive layer;
vii) an increase in dry/wet MDE ranging from about 75 to 180%, and in particular, from about 100 to 150% in comparison to an identically/similarly prepared nonwoven fabric that does not include the cohesive layer;
viii) an increase in dry/wet CDT ranging from about 20 to 200%, and in particular, from about 70 to 175% in comparison to an identically/similarly prepared nonwoven fabric that does not include the cohesive layer;
ix) an increase in dry/wet CDE ranging from about 20 to 75%, and in particular, from about 25 to 60% in comparison to an identically/similarly prepared nonwoven fabric that does not include the cohesive layer; and
x) an increase in dry/wet Mullen Burst Strength ranging from about 25 to 125%, and in particular, from about 30 to 100% in comparison to an identically/similarly prepared nonwoven fabric that does not include the cohesive layer.

In certain embodiments of the disclosure, the multilayer absorbent composite exhibits all or variations of the foregoing properties related to dry/wet MDT, MDE, CDT, CDE, and Mullen Burst Strength.

### System and Method of Preparing the Multilayer Absorbent Composite

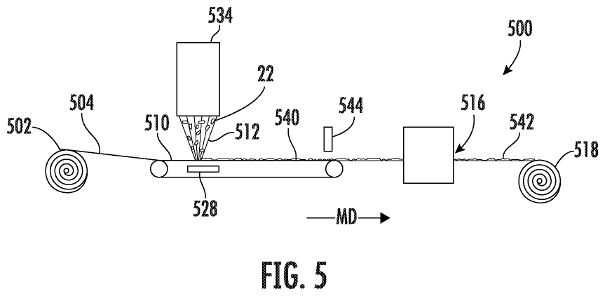

With reference to FIG. 5, for example, a system for preparing a multilayer absorbent composite is schematically shown and designated by reference character 500.

As shown, the system includes a coform apparatus 534 having a one or two meltblown spinning beams (not shown) and a source of solid additive (not shown) for forming an absorbent layer.

The system includes a cohesive layer source 502 of material for forming the cohesive layer. In the illustrated embodiment, the cohesive layer is provided preformed on a supply spool from which the cohesive material is unwound to form a cohesive layer. As discussed previously, the cohesive layer may comprise a nonwoven fabric material, cellulose material, film, or the like. It should be recognized that the cohesive layer could be formed in situ using one or more extrusion devices that are disposed upstream or downstream of the coform apparatus 534.

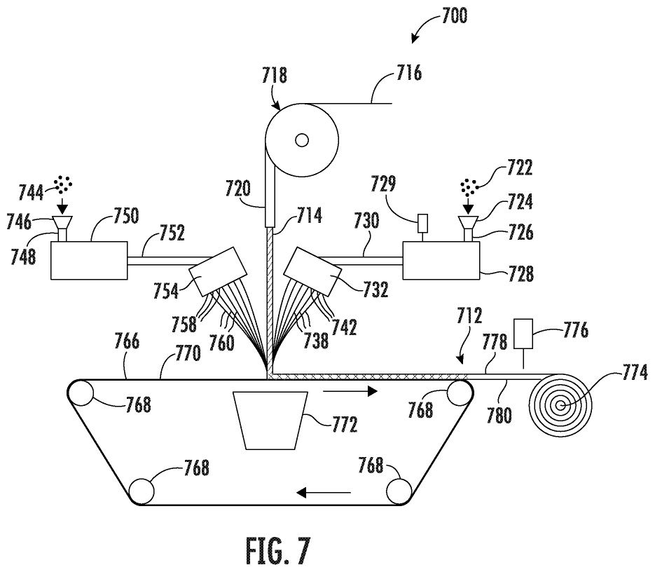

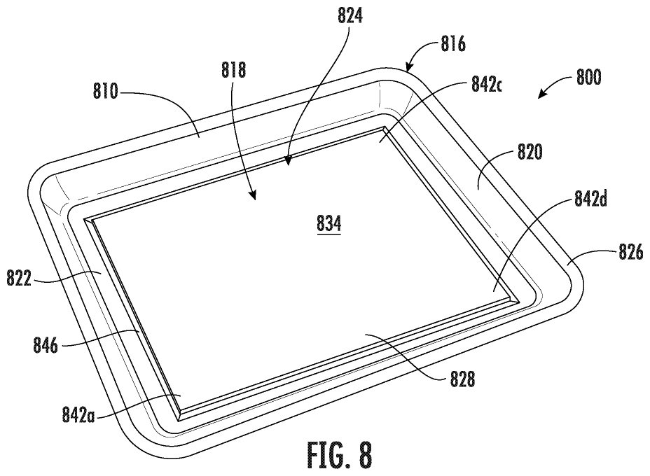

During the process, a cohesive layer 504 is provided and deposited onto a collection surface 510 (e.g., a moving belt) and is driven forward to travel in the extrusion path of the coform apparatus 534. An example of a coform apparatus that may be used in embodiments of the disclosure is described in greater detail below with respect to FIG. 7.

Coform apparatus 534 forms an air stream 512 comprising a blend of meltblown fibers and solid additives 22 that are deposited onto a surface of the cohesive layer to define an absorbent composite 540 having a cohesive layer and an absorbent layer. An example of a coform apparatus that may be used in embodiments of the disclosure is described in greater detail below with respect to FIG. 7. As discussed previously, the coform apparatus may include one or more knife-edge meltblown spinning beams or one or more multirow meltblown spinning beams.

In certain embodiments, the multilayer absorbent composite may be passed through a bonding/embossing station 516 in which the fibers are bonded to form a bonded nonwoven composite 542. A wide variety of bonding methods may be used in accordance with the invention including thermal bonding (e.g., through air bonding or calender bonding), mechanical bonding (e.g., hydroentanglement or needle punching) and chemical bonding (e.g., use of an adhesive resin). In one embodiment, the bonding station comprises a thermal bonding unit comprising a pair of opposing calender rolls.

In certain embodiments, the bonding unit comprises a chamber in which the nonwoven fabric is exposed to a stream of heated gas, such as air, and in which the temperature of the heated gas is above the softening or melting temperature of at least one polymer component of the multilayer absorbent composite.

In some embodiments, the system may comprise a hot air knife 544 which is configured to subject the nonwoven fabric to a stream of heated air. In certain embodiments, the hot air knife 544 may thermally bonds adjacent fibers of the multilayer absorbent composite to each other without further compaction of the multilayer absorbent composite.

In further embodiments, the bonding unit may comprise one or more hydraulic entanglement units which are configured to subject the nonwoven fabric to streams of high pressure water that causes the fibers to intertwine and mechanically bond together.

In some embodiments, the system may also include a pair of cooperating rolls (not shown) (also referred to herein as a “press roll”) positioned downstream from the outlet of the spin beam. In this regard, the press roll may be configured to stabilize the web of filaments by compressing web prior to delivering the web of fibers from the outlet of the spin beam towards the bonding unit. In some embodiments, for example, the press roll may include a ceramic coating deposited on a surface thereof. In certain embodiments, for instance, one roll of the pair of cooperating rolls may be positioned above the collection surface, and a second roll of the pair of cooperating rolls may be positioned below the collection surface.

In some embodiments and as shown in FIG. 5, the system may comprise a vacuum source 528 disposed below the collection surface 510 for pulling the plurality of continuous filaments from the outlet of the spin beam onto the collection surface before delivery to the bonding unit.

Finally, the bonded/embossed multilayer absorbent composite 542 moves to a winder 518, where the fabric is wound onto a roll. It should be recognized that the use of bonding/embossing unit 516 is optional depending on the desired properties and end use of the nonwoven fabric. In such cases, the nonwoven fabric will remain in a non-bonded or lightly bonded state prior to being wound onto a roll.

In some embodiments, the system may include additional devices for further modifying or treating the multilayer absorbent composite. For example, the system may include a kiss roller or similar device for applying topical treatments, such as a surfactant, to a surface of the nonwoven fabric. In some embodiments, the system may also include one or more devices for incrementally stretching the fabric. An example of such a device is a ring roller, which comprises a plurality of intermeshing rings that stretch select regions of the fabric.

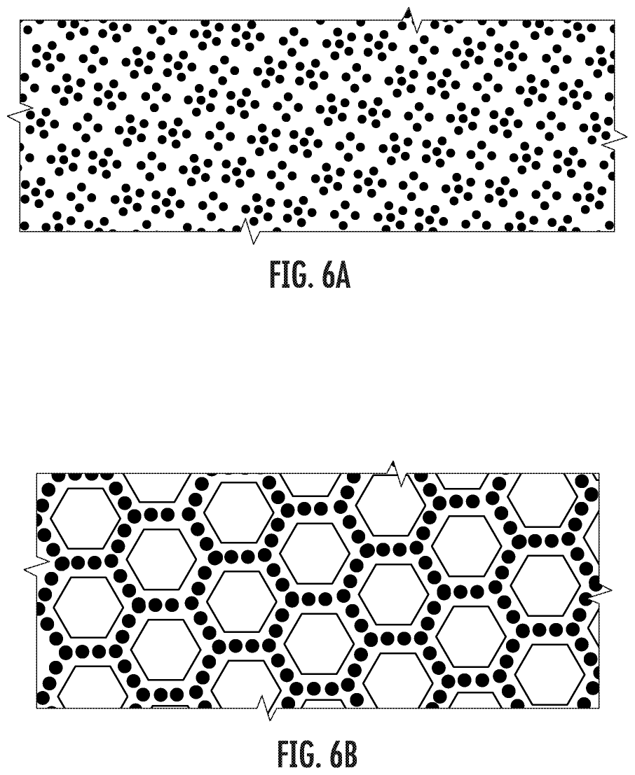

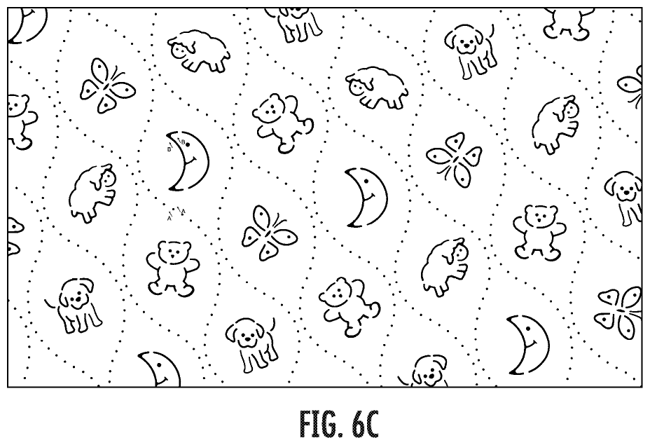

FIGS. 6A through 6C show three different representative embossing patterns that may be embossed onto the outer surfaces of the multilayer absorbent composite. The embossing pattern of 6A comprises a plurality of individual bond/emboss points that collectively defining a repeating pattern of flower like bond pattens. In the embossing pattern of FIG. 6B, the individual bond/emboss points are arranged in a repeating pattern to define a plurality of repeating hexagonal shaped bond patterns in which adjacent hexagonal shaped patterns share sides. In the embossing pattern of 6C, a pattern is shown having cartoon like animals.

For the preparation of multilayer absorbent composites having three layers or more, such as an embodiment shown in FIG. 2 in which a cohesive layer is sandwiched between a pair of absorbent layers, the system may be configured to form and deposit a first absorbent layer on a collection surface (e.g., with the coform apparatus described in FIG. 7). Thereafter, the cohesive layer may be deposited overlying the first absorbent layer. The cohesive layer may be provided on a roll from a previously prepared material or may be deposited from a spin beam, film extruder, or other apparatus for forming the cohesive layer. Next, a second absorbent layer is deposited overlying the cohesive layer. The second cohesive layer may be prepared with a second coform apparatus (see FIG. 7). Similarly, other configurations of the multilayer absorbent composite may be prepared by altering the configuration and arrangement of the system for preparing the multilayer absorbent composite.

In certain embodiments, a multilayer absorbent composite is provided in which the composite includes two opposing exterior surfaces in which each exterior surface has a static and dynamic coefficient that is different than that of the opposing exterior surface.

Referring back to FIG. 1, the multilayer absorbent composite 10 may comprise a cohesive layer 12, such as a meltblown layer, spunbond layer, or a composites, such as a spunbond-meltblown (SB), spunbond-meltblown-spunbond (SBS), or spunbond-spunbond-meltblown-meltblown (SSBB) in which the cohesive layer defines an exterior surface of the multilayer absorbent composite and the absorbent layer 14 defines a second exterior surface of the multilayer absorbent composite.

In certain embodiments, the absorbent layer 14 comprises a coform material comprising a blend of meltblown and pulp fibers in which the exterior surface of the absorbent layer predominately comprises meltblown fibers, such as a percentage of fibers defining the exterior surface of the absorbent layer is from 60 to 90 percent meltblown fibers (e.g., 64 to 86%, 70 to 82%, or 74 to 80%), based on the total number of fibers at the exterior surface of the absorbent layer 14.

For example, the percentage of meltblown fibers at the exterior surface of the absorbent layer may be at least 50%, at least 52%, at least 54%, at least 56%, at least 58%, at least 60%, at least 62%, at least 64%, at least 68%, at least 70%, at least 72%, at least 74%, at least 76%, at least 78%, at least 80%, at least 82%, at least 84%, at least 86%, at least 88%, at least 90%, at least 92%, at least 94%, at least 96%, and at least 98%, based on the total number of fibers at the exterior surface of the absorbent layer 14.

In certain embodiments, the percentage of meltblown fibers at the exterior surface of the absorbent layer may be no more than 98%, no more than 96%, no more than 94%, no more than 92%, no more than 90%, no more than 88%, no more than 86%, no more than 84%, no more than 82%, no more than 80%, no more than 78%, no more than 76%, no more than 74%, no more than 72%, no more than 70%, no more than 68%, no more than 66%, no more than 64%, no more than 62%, no more than 60%, no more than 58%, no more than 56%, no more than 54%, and no more than 52, based on the total number of fibers at the exterior surface of the absorbent layer 14.

In certain embodiments, the average static coefficient of friction (COF) for the exterior surface of the absorbent layer is from about 0.125 to 0.300, such as from about 0.130 to 0.285, from about 0.140 to 0.260, and from about 0.145 to 0.255.

In certain embodiments, the average dynamic coefficient of friction (COF) for the exterior surface of the absorbent layer is from about 0.045 to 0.200, such as from about 0.50 to 0.185, from about 0.055 to 0.70, and from about 0.056 to 0.166.

In certain embodiments, the exterior surface of the cohesive layer 12 exhibits a static COF from about 0.025 to 0.300, such as from about 0.035 to 0.285, from about 0.45 to 0.275, or from about 0.050 to about 0.260. In certain embodiments, the exterior surface of the cohesive layer 12 exhibits a dynamic COF from about 0.0005 to 0.200, such as from about 0.0007 to 0.185, from about 0.0008 to 0.175, or from about 0.001 to about 0.166.

In certain embodiments, the exterior surface of the cohesive layer 12 comprises or consists of spunbond fibers and the surface exhibits a static COF from about 0.025 to 0.10, such as from about 0.035 to 0.085, from about 0.045 to 0.075, or from about 0.050 to about 0.060. In certain embodiments, the exterior surface of the cohesive layer 12 consists or comprises spunbond fibers and the exterior surface exhibits a dynamic COF from about 0.0005 to 0.0015, such as from about 0.0007 to 0.0014, from about 0.0008 to 0.0013, or from about 0.0009 to about 0.0011.

In certain embodiments, the exterior surface of the cohesive layer 12 comprises or consists of meltblown fibers and the surface exhibits a static COF from about 0.200 to 0.300, such as from about 0.225 to 0.285, from about 0.240 to 0.275, or from about 0.250 to about 0.260. In certain embodiments, the exterior surface of the cohesive layer 12 consists or comprises meltblown fibers and the exterior surface exhibits a dynamic COF from about 0.100 to 0.200, such as from about 0.125 to 0.185, from about 0.150 to 0.175, or from about 0.160 to about 0.170.

In certain embodiments, the multilayer absorbent composite comprises 1) a first exterior surface comprising and/or consisting of a blend of meltblown and pulp fibers, and the first exterior surface exhibits a static COF from about 0.145 to 0.165 and a dynamic COF from about 0.05 to 0.080; and 2) a second exterior surface comprising and/or consisting of meltblown fibers in which the second exterior surface exhibits a static COF from about 0.225 to 0.275 and a dynamic COF from about 0.135 to 0.175.

In certain embodiments, the exterior surface of the absorbent layer (i.e., layer that is a blend of meltblown and pulp fibers) exhibits a static COF that is from about 30 to 90% greater than that of the opposite exterior surface of the multilayer absorbent composite. Such as a percent increase in static COF ranging from about 40 to 80%, 50 to 70%, and from 55 to 65%.

In certain embodiments, the exterior surface of the absorbent layer (i.e., layer that is a blend of meltblown and pulp fibers) exhibits a dynamic COF that is from about 120 to 160% greater than that of the opposite exterior surface of the multilayer absorbent composite. Such as a percent increase in dynamic COF ranging from about 125 to 150%, 130 to 145%, and from 135 to 145%.

### System and Method for Preparing the Absorbent Layer

With reference to FIG. 7, a system 700 and associated method is shown for producing a composite nonwoven fabric 712 (e.g., a coform nonwoven) for use as the absorbent layer in the multilayer absorbent composite. As discussed previously, the absorbent layer comprises a blend of thermoplastic fibers and a plurality of solid additives.

The composite nonwoven fabric 712 can have a high loft. The composite fabric 712 is a matrix formed by introducing a stream of fibers of a first material 714 between two polymer streams. By “matrix” it is meant a situation or surrounding substance within which something else originates, develops or is contained. The first material 714 comprises a solid additive and can be absorbent fibers or non-absorbent fibers. Examples of suitable solid additives for use as the first materials are discussed previously. In a preferred embodiment, the solid additive, and hence, the first material, comprises a cellulose-based material, such as pulp.

The thermoplastic fibers may be monocomponent or multicomponent. The thermoplastic fibers may also be continuous or discontinuous. Examples of suitable material for the thermoplastic fibers are discussed previously.

Still referring to FIG. 7, the first material 714 can enter the system or process 700 in the form of sheets or mats 716 which are fed into a fiberizer 718. The fiberizer 718 can vary in size, shape and design. The fiberizer 718 functions to break the sheets or mats 716 into a plurality of individual fibers 714. The fiberizer 718 can vary. For example, the fiberizer 718 can be a hammer mill, disk mill, a picker roll, or some other mechanism known to those skilled in the art. The fiberizer 718 contains a discharge nozzle 720 that delivers the fiberized pulp fibers between two filament streams, 738 and 760. The discharge nozzle 720 can be designed according to the teachings of U.S. Pat. No. 8,122,570 issued to Jezzi on Feb. 28, 2012 in order to deliver uniform pulp fibers across the width of the machine. This patent is incorporated by reference and made a part hereof. Alternatively, the solid additives, such as pulp fibers, may be manually introduced or introduced directly from pre-opened bales, rolls, bags, boxes, and the like.

The throughput of the first material 714 can be controlled by the input feeding speed of the rolls, sheets or mats 716, as well as by the gas (air) blower speed of a blower connected to the fiberizer 718 or the nozzle 720. Because of the high strength of the fibers of the first and second filament streams 738 and 760 respectively, which will be discussed below, the final concentration of the fibers of the first material 714 in the composite nonwoven fabric 712 can range from between about 10% to about 80%. Desirably, the final concentration of the fibers of the first material 714 in the composite nonwoven fabric 712 can range from between about 15% to about 60%. More desirably, the final concentration of the fibers of the first material 714 in the composite fabric 712 can range from between about 20% to about 40%. Even more desirably, the final concentration of the fibers of the first material 714 in the composite nonwoven fabric 712 can range from between about 50% to about 80%.

The individual fibers 714 are conveyed downward through the nozzle 720. A gas, such as air, is supplied to the upper end of the nozzle 720 to serve as a medium for conveying the fibers of the first material 714 through the nozzle 720.

The gas (air) may be supplied by any conventional arrangement such as, for example, an air blower (not shown).

It is envisioned that other materials, such as an additive, may be added to or be entrained in the gas (air) stream to treat the fibers of the first material 714, if desired. The individual fibers of the first material 714 are typically conveyed through the nozzle 720 at about the velocity at which the fibers of the first material 714 leave the fiberizer 718. In other words, the fibers of the first material 714 that enter the nozzle 720 generally maintain their velocity in both magnitude and direction. U.S. Pat. No. 4,100,324, issued to Anderson et al. teaches such an arrangement and is incorporated by reference and made a part hereof.

Still referring to FIG. 7, a first polymer resin 722, in the form of small solid pellets, granules or powder, is placed into a hopper 724 and is then routed through a conduit 726 to an extruder 728.

In the extruder 728, the first polymer resin 722 is heated to an elevated temperature. The temperature will vary depending on the composition and melting point of a particular polymer. Usually, the first polymer resin 722 is heated to a temperature at or above its melt temperature. The molten, first polymer resin 722 is transformed into a molten material (polymer) is then routed through a conduit 730 to spin beam 732.

Spin beam 732 is configured and arranged to extrude continuous filaments comprising a blend of a polymer resin and one or more additives/polymer resins. In certain embodiments, the spin beam may comprise a meltblown spin beam such as a multirow meltblown spin beam or a knife-edge spin beam. During extrusion the filaments 738 are contacted by gas (air) jets (not shown) which draw the filaments 738.

In certain embodiments, each of the filaments 738 has an average diameter of less than about 10 microns. Desirably, each of the filaments 738 has an average diameter ranging from between about 1 micron to about 10 microns. More desirably, each of the filaments 738 has an average diameter ranging from between about 1 micron to about 9 microns.

The first polymer resin 722 can vary in composition and may be selected from those discussed previously. In one embodiment, the first polymer resin 722 can be a thermoplastic.

In certain embodiments, the system 700 may include a second spin beam 754 and associated hopper. In this regard, while still referring to FIG. 7, a second polymer resin 744, in the form of small solid pellets, granules or powder, is placed into a hopper 746 and is then routed through a conduit 748 to an extruder 750. In the extruder 250, the second polymer resin 244 is heated to an elevated temperature. The temperature will vary depending on the composition and melt temperature of a particular polymer. Usually, the second polymer resin 744 is heated to a temperature at or above its melting temperature.

In certain embodiments, one or more of the first and second polymer resins may be blended with an elastomeric polymer as discussed previously. For example, the first polymer resin 722 may comprise a blend of a polyolefin polymer and an elastomeric polymer. In some embodiments, the first polymer resin comprises a blend of a polyolefin polymer resin and a elastomeric polymer, and the second polymer resin 744 does not include the elstomeric polymer.

In certain embodiments, an optional source of high loft additive (not shown) is in communication with extruder 750. Spin beam 750 is configured and arranged to extrude continuous filaments comprising a blend of a polymer resin and optional melt additives/polymer resins.

The melted, second polymer resin 744 is transformed into a molten material (polymer) which is then routed through a conduit filaments 752 to a spin beam 754. The spin beam 754 contains a plurality of nozzles 758 through which the molten material is extruder into filaments 760. The filaments 760 are contacted by gas (air) jets (not shown) which draw the filaments 760.

In certain embodiments, each of the filaments has an average diameter of less than about 10 microns. Desirably, each of the filaments 760 has an average diameter ranging from between about 1 micron to about 10 microns. More desirably, each of the filaments 760 has an average diameter ranging from between about 1 micron to about 9 microns.

The second polymer resin 744 can be identical to the first polymer resin filaments 722 or be different from the first polymer resin 722. The compositions of the first and second polymer resins, 722 and 744 respectively, will depend on the final composite nonwoven fabric 712 one wishes to produce. Likewise, the characteristics, such as diameter, tensile strength, etc. of the first filaments 738 can be identical to the characteristics of the second filaments 760 or be different therefrom. Generally, when the first and second polymer resins, 722 and 744 respectively, are the same, filaments will have the same diameter and strength. However, the first and second filaments 738, 760 could have different characteristics, such as diameter, strength, etc. if desired. In addition, the characteristics of the first and second filaments 738, 760 can be changed if the spinneret assemblies and the nozzles 742 and 758 have different physical dimensions, configurations and/or design. In certain embodiments, filaments 738 and 760 can be identical, while in other applications, they can be different.

Still referring to FIG. 7, a stream of the fibers of the first material 714 is comingled between the streams of the first and second filaments, 738, 760 respectively. A majority of the fibers of the first material 714 will be positioned or sandwiched between the first and second first filaments, 738, 760 respectively, present in the first and second filament streams. In other words, a higher concentration of the fibers of the first material will be present in the middle portion of the finished, composite nonwoven fabric 712. The ratio of the fibers of the first material 714 to the ratio of the first and second filaments 738, 760 respectively, can vary.

It should be understood that the denier of the fibers of the first material 714, for example, absorbent staple/pulp fibers, can be greater than the denier of either the first or second filaments, 738, 760 respectively. By “denier” it is meant a unit of fineness for rayon, nylon and silk, based on a standard mass per length of 1 gram per 9,000 meters of yarn.

The first filaments 738 are formed from the first polymer resin 722 and the second filaments 760 are formed from the second polymer resin 744. The first polymer resin 722 can be identical to or be different from the second polymer resin 744. Each of the separate streams of the first and second filaments 738, 760 respectively, will join, merge or intersect with the steam of fibers of the first material 714.

In the illustrated embodiment, the spin beams 728 and 750 are inclined at an angle theta Θ to the nozzle 720. This means that the separate streams of the first and second polymer filaments 738, 760, will contact the stream of the fibers of the first material 714 at an angle of inclination theta Θ. The angle of inclination theta Θ can range from between about 10° to about 90°. Desirably, the angle of inclination theta Θ can range from between about 30° to about 70°. More desirably, the angle of inclination theta Θ can range from between about 40° to about 65°. Even more desirably, the angle of inclination theta Θ can range from between about 40° to about 50°.

As discussed previously, spin beams 728, 750 may be used to prepare filaments comprising monocomponent fibers or multicomponent fibers. In addition, the filaments may comprise blends of polymer or may comprise a single homopolymer. In some embodiments, the composite nonwoven fabric 712 may contain bicomponent fibers wherein the fibers have a sheath-core configuration with the core formed from one polymer and the surrounding sheath formed from a second polymer. Still another option is to produce the composite nonwoven fabric 712 from bicomponent fibers where the fibers have a side-by-side configuration. Those skilled in the polymer arts will be aware of various fiber designs incorporating two or more polymers.

In certain embodiments, the filaments may comprise bicomponent fibers having a concentric, eccentric or D-centric cross-section. In certain embodiments, the filaments may comprise crimps that extend longitudinally along the length of the filaments. In some embodiments, the spin beam may include one or more polymer distribution plates that are configured to produce a nonwoven fabric comprising fibers having multiple cross-sections that are different from each other in a single layer.

Referring again to FIG. 7, the system and process 700 further includes depositing the comingled streams of fibers of the first material 714 and the first and second filaments, 738 and 760 respectively, onto a collection surface, such as a forming wire 766. The forming wire 766 can be constructed as a closed loop which travels around a plurality of rollers 768. Four spaced apart rollers 768, 768, 768 and 768 are shown in FIG. 7. One of the rollers 768 can be a drive roller which causes the forming wire 766 to move or rotate in a desired direction. In FIG. 7, the forming wire 266 is moving in a clockwise direction, see the arrows. The forming wire 266 has a foraminous surface 770 which contains a plurality of very small openings (not shown). Various kinds and types of forming wires 766 are commercially available today. Albany International Co. of Albany, N.Y. manufactures and sell a variety of such forming wires 766. Those skilled in the art of forming webs are knowledgeable about the various kinds and types of forming wires 766.

A vacuum source 272 (or multiple vacuum sources in some embodiments) is located beneath the forming wire 766. The vacuum source 272 can vary in design and construction. For example, the vacuum source 772 can be a vacuum box that is positioned directly below the point of contact of the comingling streams or be located slightly downstream from this point. The vacuum source 772 exerts a force on the various fibers of the first material 714 and the first and second filament 738 and 760 respectively, and supports the composite nonwoven fabric 712. The three streams will accumulate and the fibers forming the composite nonwoven fabric 712 will solidify and be advanced in the direction the forming wire 766 is moving. The composite nonwoven fabric 712 can then be wound up onto a wind-up spindle 774. At a predetermined length, the composite nonwoven fabric 712 can be severed or cut by a cutter 776. For example, the composite nonwoven fabric may be slit in line following formation. Various types of web cutter 776 are commercially available and are well known to those skilled in the art.

In some embodiments, additional layers may be added to the composite nonwoven fabric 712. For example, meltblown, spunbond, or carded layers, for example, may be added to the composite nonwoven fabric. Further, one or more additional layers formed using various spin beams, such as meltblown and spunbond spinbeams. The system may also include multiple systems 700 depicted in FIG. 7.

In some embodiments, the composite nonwoven fabric may also be subject to a bonding step, such as mechanical bonding, thermal bonding, or chemical bonding. Processes and apparatus for bonding are discussed previously in connection with the system shown in FIG. 5.

Multilayer structures in accordance with embodiments can be prepared in a variety of manners including continuous in-line processes where each layer is prepared in successive order on the same line, or depositing a meltblown layer on a previously formed spunbond layer. The layers of the multilayer structure can be bonded together to form a multilayer composite sheet material using thermal bonding, mechanical bonding, adhesive bonding, hydroentangling, or combinations of these. In certain embodiments, the layers are thermally point bonded to each other by passing the multilayer structure through a pair of calender rolls.

Multilayer absorbent composites prepared in accordance with embodiments of the invention may be used in wide variety of articles and applications. For instance, embodiments of the invention may be used for personal care applications, for example products for babycare (diapers, wipes), for femcare (pads, sanitary towels, tampons), for adult care (incontinence products), or for cosmetic applications (pads), agricultural applications, for example root wraps, seed bags, crop covers, industrial applications, for example work wear coveralls, airline pillows, automobile trunk liners, sound proofing, and household products, for example mattress coil covers and furniture scratch pads.

In certain embodiments, multilayer absorbent composites prepared in accordance with embodiments of the invention may be used animal wipe applications, such as use as a pet wipe.

In certain embodiments, Multilayer absorbent composites prepared in accordance with embodiments of the invention may be used as a hard surface disinfecting wipe. Such wipes may be particularly useful in the hospitality industry, food service industry, and medical disinfecting applications.

In certain aspects, the disclosure is directed to an absorbent pad comprising the multilayer absorbent composite for use in food packaging applications. For example, embodiments of the disclosure may be directed to a package comprising an individually wrapped container in which a food product, such as meat, poultry, seafood, fruit, vegetables, and the like are packaged for display. Advantageously, the multilayer absorbent composite may be disposed in the package to absorb any liquids exuded by the food product.

With reference to FIG. 8, a package assembly comprising the multilayer absorbent composite is shown and designated broadly by reference character 800. The package assembly 800 may include a package base 810 that may advantageously be used to package a food product that exudes liquids. Such food products may include various foods such as, e.g., fresh red meat products (e.g., beef, veal, lamb, pork, etc.), poultry (chicken, turkey, etc.), fish, produce (fruits and vegetables), etc.

As shown, package base 810 generally includes a tray 816 and an absorbent pad 818 comprising the multilayer absorbent composite in accordance with one or more embodiments of the disclosure. As will be explained in further detail below, absorbent pad 818 comprises a multilayer absorbent composite adapted to absorb exuded liquids from a food product.

Tray 816 may include side walls 820 and a bottom 822 as shown. Side walls 820 and bottom 822 define a cavity 824 in which food product may be contained. Tray 816 may further include a peripheral flange 826 extending outwardly from the side walls 820, which provides a surface to which a lidding film may be attached, e.g., by heat-sealing the film to the flange, in order to enclose the product within the tray cavity 824. Alternatively, the tray may be over-wrapped by a film, in which case the film is secured at the underside of the tray-bottom, or placed in an over-wrap bag. In the latter two instances, flange 826 may be unnecessary. Tray 816 can have any desired configuration or shape, e.g., rectangular, round, oval, etc. Similarly, flange 826 may have any desired shape or design.

In certain embodiments, tray 816 may simply be a flat sheet. In this embodiment, a lidding film may be attached, e.g., heat-sealed, to the edges of the sheet-like tray to enclose the product, or the tray/product may be over-wrapped.

Suitable materials from which tray 816 can be formed include, without limitation, polyvinyl chloride, polyethylene terephthalate, polystyrene, polyolefins such as high density polyethylene or polypropylene, paper pulp, nylon, polyurethane, bio-based polymers, etc. The tray may be foamed or non-foamed as desired.

When food product is an oxygen-sensitive food product, both the tray 816 and lidding or over-wrap film preferably provide a barrier to the passage of oxygen therethrough. In this case, a material that provides a barrier to the passage of oxygen would preferably be included in both the tray and lidding or over-wrap film, e.g., vinylidene chloride copolymer, nylon, polyethylene terephthalate, ethylene/vinyl alcohol copolymer, etc. In the case of a foam tray, oxygen-barrier functionality may be provided in the form of a film, which may be laminated to the inner or outer surface of the tray, and which includes an oxygen barrier material.

If package assembly 800 is to be used to form a vacuum-skin package, substantially no gasses will be present in cavity 824 because substantially all gas will be evacuated prior to the application of a lidding film. Alternatively, when package assembly 800 is used to form a modified-atmosphere package, a gas that extends the shelf-life of food product may be present in cavity 824, generally following the removal of air therefrom. Such gases, which replace the evacuated air, include, e.g., carbon dioxide, nitrogen, argon, carbon monoxide, etc., and mixtures of such gases, such as a mixture of carbon dioxide and nitrogen.

In certain embodiments, a food product is placed on a surface 834 of the absorbent pad 818 such that the absorbent pad is disposed between the food product and the tray 816.

In certain embodiments, the tray 816 may be substantially rigid, support member 828 and preferably is capable of supporting a product without significant deformation. An example of significant deformation would be if the support member 828 conformed so closely to a food product that it attached itself to the product such that, upon removal of the product from the package, the entire absorbent pad 818 is pulled from tray 816 due to the adherence of support member 828 with the food product.

In certain embodiments, the absorbent pad 818 may be adhered to bottom surface of tray 816. This may be achieved by applying discrete quantities of adhesive to a lower surface of the absorbent pad 818. quantities, e.g., individual drops, are preferred to a continuous band of adhesive because the discrete quantities allow exuded liquid to flow around the adhesive and under the absorbent pad so a lower layer of the absorbent pad can absorb the liquid. For example, when the absorbent pad 818 has a square or rectangular shape as shown, a drop of adhesive, e.g., hot-melt, liquid, or pressure-sensitive adhesive, may be applied to each of the four corners 842a-d at a lower surface of absorbent pad 818 (adhesive not shown).

In certain embodiments, the absorbent pad 818 comprises a mat of an absorbent material (e.g., the multilayer absorbent composite shown in FIG. 1-4), which is enclosed within an envelope comprising two sheets of plastic material, which are sealed along their edges. Typically, at least one of the sheets may be apertured to allow exuded liquid to enter the envelope for absorption by the absorbent material.

### EXAMPLES

The following examples are provided for illustrating one or more embodiments of the present invention and should not be construed as limiting the invention.

Unless otherwise defined, the technical terms used in the following embodiments have the same meaning as commonly understood by those skilled in the art to which this invention pertains.

In the following examples, inventive examples comprising multilayer absorbent composites were prepared. The inventive examples comprised a cohesive layer on which an absorbent layer comprising a blend of thermoplastic fibers and pulp fibers was deposited. The resulting composites were embossed and then evaluated in comparison to control samples that did not include the absorbent layer.

Unless otherwise stated, multilayer absorbent composites in the following examples were prepared with a Reicofil coform line produced by Reifenhaeuser. The coform line included two knife-edge meltblown beams configured to produce two converging streams of meltblown fibers. Unless otherwise indicated all percentages are weight percentages. The materials and test methods used in the examples are identified below.

### Test Methods:

Basis weight was evaluated according to test method WSP 130.1.

Wet Cross-Direction (CD) tensile (N) was evaluated according to test method WSP 110.4 (09).

Wet Cross-Direction Elongation (CDE) at Peak was evaluated according to test method WSP 110.4 (09).

Wet Machine Direction (MD) Tensile (N) was evaluated according to test method WSP 110.4 (09).

Wet Machine Direction Elongation (MDE) at Peak (%) was evaluated according to test method WSP 110.4 (09).

Dry thickness (mm) was evaluated under 0.5 kPA compression.

Mullen Burst Strength (PSI) was measured according to test method NWSP 030.1.R0 (15).

Percent Absorbency was measured based on NWSP 010.1.R0 (15) entitled 8.2 The liquid Absorptive Capacity. In this procedure, a sample of the material to be tested having a weight of at least 0.5 grams is obtained. The sample is weighed to obtain a Pre-Soak Weight. The sample is soaked in cavicide for 1 minute. The sample is then hung and dried for a minute. The sample is then reweighed to obtain a Post Soak Weight, The percent absorbency is then calculated by dividing the Presoak Weight by the Post Soak Weight and then multiplied by 100.

Air Permeability measurements were performed with a Textest FX3300 Air Permeability having a test head of 38 cm² and at a test pressure of 125 Pa. Allow approximately 10 minutes for the unit to warm up. Reset the unit to zero. Place the sample, free from tension, on the test head. Press down on the clamping arm to secure the sample and start the vacuum pump. Read and record the test result.

Percent Opacity measurements are obtained in accordance with GACS 95000582.003 pf Procter & Gamble. The method utilizes a Hunter Lab Colorimeter AGR00761 instrument and a standard port plate. The color scale is set to XYZ, the observer to 100, and the illuminant to D65 (on the Color Data Table of the display). After turning on the instrument and the computer desktop, the EZMQC icon is selected. Standardize the instrument with the standard port plate by selecting “sensor”>STANDARDIZE. Follow the prompts on the screen, and place the black glass and whit tile at the port in order. After standardization, place the sample on the port and then select “read sample” icon and then follow the prompts on the screen to place the port plate.

Coefficient of Friction (COF) was measured according to ASTM D1894. In this method, the force is measured to move a sled whose base is covered by fabric with fiber side of interest downward against the specified surface. Testing details include Load cell at 100N, Clamps Distance at 130 mm and Crosshead Speed=150 mm/minute.

Index of Formation was measured with a Micro-Scanner Model LAD07 utilizing a diffused quartz halogen lamp light source, available from OpTEST™ Equipment Inc. of Ontario Canada. The procedures used are the same as set forth in U.S. Pat. No. 8,017,534 (the contents of which are hereby incorporated by reference).

### Materials

“PP-1” refers to a meltblown grade polypropylene homopolymer resin having a melt flow rate of 1250 g/10 min (measured with ISO Method 1133) and a density of 0.905 g/cm³ (measured with ISO Method 1183-1) available from Braskem under the product code H 155.

“PP-2” refers to a meltblown grade polypropylene homopolymer resin having a melt flow rate of 1,400 g/10 min (measured with ASTM D1238) available from PolyQuest under the tradename PQPPH-B-1400F.

“PP-3” refers to a spunbond grade polypropylene homopolymer resin having a melt flow rate of 24 g/10 min (measured with ASTM D1238) and a density of 0.900 g/cm³ (measured with an internal ExxonMobil method) available from ExxonMobil under the tradename EXCEEED™ pp 3854.

“PP-4” refers to a meltblown grade polypropylene homopolymer resin having a melt flow rate of 1,300 g/10 min (measured with ASTM D1238) and a density of 0.905 g/cm³ (measured with ASTM D1505) available from TotalEnergies under the Product number 3962.

“PP-5” refers to a spunbond grade polypropylene homopolymer resin having a melt flow rate of 35 g/10 min (measured with ASTM D1238) available from Heartland Polymers under the product number H5235G.

“EPP” refers to an elastomeric polyolefin copolymer having an MFR of 18 g/10 min available from Exxon Mobil under the tradename VISTAMAXX™ 7050BF.

“A-1” refers to a wetting agent melt additive in a polypropylene carrier available from Techmer PM under the product code PPM15560.

“PULP” refers to a treated fluff wood pulp available from Georgia Pacific under the product code GP 4723.

“SMS-1” refers to a composite nonwoven with a SMS configuration and having a basis weight of 12 g/m², and available from Fitesa Simpsonville. Both spunbond layers and the meltblown layer comprised polypropylene. The SMS was calender bonded with an oval elliptical bonding pattern.

“SM-1” refers to a composite nonwoven having an SM configuration and having a basis weight of 12 g/m², and available from Fitesa Simpsonville. The composite was hydrophobic (e.g., contact angle greater than) 90° and being relatively unbonded prior to being joined with a coform layer. The fibers of the spunbond layer comprised polypropylene filaments prepared from PP-5, and the meltblown fibers comprised polypropylene fibers prepared from PP-4.

“SM-2” refers to a composite nonwoven having an SM configuration and having a basis weight of 12 g/m², and available from Fitesa Simpsonville. The composite was hydrophobic (e.g., contact angle greater than) 90° and lightly embossed. The fibers of the spunbond layer comprised polypropylene filaments prepared from PP-5, and the meltblown fibers comprised polypropylene fibers prepared from PP-4.

“SM-3” refers to a composite nonwoven having an SM configuration and having a basis weight of 16 g/m², and available from Fitesa Simpsonville. The composite was hydrophilic (e.g., contact angle less than) 90° and lightly embossed. The fibers of the spunbond layer comprised polypropylene filaments prepared from PP-5, and the meltblown fibers comprised polypropylene fibers prepared from PP-4.

“SM-4” refers to a composite nonwoven having an SM configuration and having a basis weight of 18 g/m², and available from Fitesa Simpsonville. The composite was hydrophilic (e.g., contact angle less than) 90° and lightly embossed. The fibers of the spunbond layer comprised polypropylene filaments prepared from PP-5, and the meltblown fibers comprised polypropylene fibers prepared from PP-4.

“SM-5” refers to a composite nonwoven having an SM configuration and having a basis weight of 20 g/m², and available from Fitesa Simpsonville. The composite was hydrophilic (e.g., contact angle less than) 90° and lightly embossed. The fibers of the spunbond layer comprised polypropylene filaments prepared from PP-5, and the meltblown fibers comprised polypropylene fibers prepared from PP-4.

“SSMM-1” refers to a composite nonwoven having an SSMM configuration and a basis weight of 12 g/m², and available from Fitesa Simpsonville. The composite was hydrophilic (e.g., contact angle less than) 90° and lightly embossed. The fibers of the spunbond layers comprised polypropylene filaments prepared from PP-5, and the meltblown fibers of the meltblown layers comprised polypropylene fibers prepared from PP-4.

### Inventive Example 1

In Inventive Example 1, a layer of SMS-1 was continuously unwound from a nonwoven supply roll comprising SMS-1 to define a cohesive layer. The cohesive layer was then passed through the line below a coform forming apparatus for forming an absorbent layer. The coform forming apparatus comprised a pair of knife-edge meltblown beams (meltblown beam A and meltblown beam B) that were angled relative to each other to provide a pair of converging streams of meltblown fibers. A full width stream of pulp fibers was introduced between the pair of converging streams of meltblown fibers. The pulp fibers intermixed with the two streams of meltblown fibers to form a combined stream collectively comprised of the meltblown fibers and pulp fibers (e.g., to form a coform layer). Meltblown beam A provided a stream of meltblown fibers comprising 85 weight percent of PP-2 and 10 weight percent of EPP, and 5% by weight of erucamide additive (30% masterbatch for a concentration of 1.5% erucamide, based on the total weight of the blend) based on the total weight of the blend. Meltblown beam B provided the same polymer blend as meltblown beam A. The pulp stream comprised the PULP wood pulp fibers. The weight ratio of pulp fibers to polymer fibers in the absorbent layer was 60/40.

The combined stream comprising the meltblown fibers and pulp fibers was deposited onto the cohesive layer to form an absorbent layer and define a composite multilayer structure. The resulting composite nonwoven was then embossed by passing the multilayer absorbent composite through a pair of heated rolls in which one of the rolls was patterned with a hexadot embossing pattern with a calender roll having a patterned roll temperature of 130° C. and an anvil roll temperature of 120° C. The multilayer absorbent composite was then evaluated for perforation resistance. The results are summarized in Table 1, below.

### Comparative Example 1

Comparative Example 1 did not include a cohesive layer. In Comparative Example 1, an absorbent layer was similar to the one of Inventive Example 1 was prepared with the same materials and system with the exception that the absorbent layer was deposited onto a moving collection surface (not deposited onto a previously formed SMS structure). The weight ratio of pulp fibers to polymer fibers in Comparative Example 1 was 52/48. The basis weight of Comparative Example 2 was controlled to be approximately the same as the basis weight of Inventive Example 1.

### Inventive Example 2

Inventive Example 2 was identical to the multilayer absorbent composite of Inventive Example 1 with the exception that the resulting composite was not subject to an embossing step. The results are summarized in Table 1, below. The weight ratio of pulp fibers to polymer fibers in the absorbent layer was 60/40.

### Comparative Example 2

Comparative Example 2 did not include a cohesive layer. In Comparative Example 2, an absorbent layer was similar to the one of Inventive Example 2 was prepared with the same materials and system with the exception that the absorbent layer was deposited onto a moving collection surface (not deposited onto a previously formed SMS structure). The weight ratio of pulp fibers to polymer fibers in Comparative Example 2 was 52/48.

TABLE 1
Properties of Inventive and Comparative Examples 1-2

| | | | | | | | | Wet |
|---|---|---|---|---|---|---|---|---|
| | Basis | Dry | Wet | Wet | Wet | Wet | | Mullen |
| Example | weight | Caliper | MDT | MDE | CDT | CDE | Absorbency | Burst |
| No. | (gsm) | (μm) | (N/5 cm) | (%) | (N/5 cm) | (%) | (%) | (PSI) |
| Inventive | 60.4 | 742 | 37 | 35.6 | 14.1 | 61.5 | 894.4 | 18.5 |
| Example 1 | | | | | | | | |
| Comparative | 59.3 | 830 | 10.5 | 17.4 | 3.8 | 48.9 | 957.7 | 10.0 |
| Example 1 | | | | | | | | |
| Inventive | 62.1 | 1020.0 | 34.9 | 72.3 | 14.9 | 82.2 | 989.5 | 18.5 |
| Example 2 | | | | | | | | |
| Comparative | 58.7 | 1070 | 9.3 | 29.7 | 5.5 | 53.3 | 1144.8 | 12.5 |
| Example 2 | | | | | | | | |

Values provided in Table 1 are based on an average of 10 samples.

From Table 1, it is seen that the presence of the cohesive layer substantially increased the mechanical properties of the multilayer absorbent composite in comparison to a coform nonwoven that did not include the cohesive layer. In particular, the Wet MDT for the inventive examples exhibited increases in Wet MDT ranging from 250 to 280 percent and increases in the Wet MDE ranging from about 100 to 145 percent in comparison to the comparative examples. Similarly, the Wet CDT for the inventive examples exhibited increases in Wet CDT ranging from about 70 to 171 percent and increases in the Wet CDE ranging from about 25 to 55 percent in comparison to the comparative examples.

The drastic increase in mechanical properties while the multilayer absorbent composite is in a wet state is surprising in view that the cohesive layer is present in a minor proportion based on the overall weight of the multilayer absorbent composite. Both the inventive and comparative examples had similar basis weights; however, the inclusion of the cohesive layer provided a composite nonwoven having superior mechanical properties, which result in the multilayer absorbent composite being particularly useful as a wet wipe.

The inventive multilayer absorbent composites also demonstrated improvements with respect to the Mullen Burst Strength of the composite. As seen in Table 2, the multilayer absorbent composites exhibited average increases in a Wet Mullen Burst strength greater than 40 percent, and in particular, increases ranging from about 45 to 80 percent in comparison to the nonwoven fabrics of the comparative examples. Mullen Burst strength provides a good representation of a material's ability to resist perforation. The inventive examples demonstrate that the inventive multilayer absorbent composites have improved properties with respect to the reduction and/or prevention in the formation of tears, rips, punctures, holes and the like in the multilayer absorbent composite.

TABLE 2
Comparison of Inventive Examples
1-2 and Comparative Examples 1-2

| | | | | | Increase |
|---|---|---|---|---|---|
| | Increase | Increase | Increase | Increase | Wet Mullen |
| | in Wet | in Wet | in Wet | in Wet | Burst |
| | MDT | MDE | CDT | CDE | strength |
| Sample Comparison | (%) | (%) | (%) | (%) | (%) |
| Inventive Example | 252.4 | 104.6 | 73.0 | 25.7 | 80.0 |
| 1 vs. Comparative | | | | | |
| Example 1 | | | | | |
| Inventive Example | 275.3 | 143.4 | 170.9 | 54.2 | 48 |
| 2 vs. Comparative | | | | | |
| Example 2 | | | | | |

### Inventive Example 3

In Inventive Example 3, a layer of SM-1 was continuously unwound from a nonwoven supply roll comprising SM-1 to define a cohesive layer. The cohesive layer was then passed through the line below the coform forming apparatus of Inventive Example 1 for forming an absorbent layer. The cohesive layer was oriented and arranged so that the absorbent layer was formed overlying the spunbond layer such that the meltblown layer of SM-1 defined an exterior surface of the multilayer absorbent composite.

In the coform forming apparatus both Meltblown beams A and B provided a stream of meltblown fibers comprising PP-1. The pulp stream comprised the PULP wood pulp fibers. The weight ratio of pulp fibers to polymer fibers in the absorbent layer was 60/40 and the targeted basis weight of the absorbent layer was 45 gsm. The resulting multilayer absorbent composite was relatively unembossed.

### Inventive Example 4

Inventive Example 4 was prepared in relatively the same manner as Inventive Example 3 with the exception that the cohesive layer comprised SM-2 in which the SM-2 layer was embossed by passing the SM-2 material through a calender bonder. The absorbent layer of the multilayer absorbent composite had a weight ratio of pulp fibers to polymer fibers that was 60/40 and a targeted basis weight of the absorbent layer was 45 gsm. The multilayer absorbent composite was embossed with a hexadot bond pattern.

### Inventive Examples 5-6

Inventive Examples 5 and 6 were prepared in a similar manner to Inventive Example 4 with the exception that Meltblown beams A and B of the coform forming apparatus provided a stream of meltblown fibers comprising 92.5 weight percent of PP-1 and 7.5 weight percent of A-1. The absorbent layer of the multilayer absorbent composite had a weight ratio of pulp fibers to polymer fibers that was 60/40 and a targeted basis weight of the absorbent layer was 45 gsm. The multilayer absorbent composite was embossed with a hexadot bond pattern.

### Inventive Examples 7-9

In Inventive Examples 7-9, SM-3, SM-4, and SM-5 were used as the cohesive layer, respectively. As in the previous examples, the SM layers were oriented so that the absorbent layer was deposited directly onto the spunbond layer so that the meltblown layers formed the exterior surfaces in each of Inventive Examples 7-9.

Meltblown beams A and B of the coform forming apparatus provided a stream of meltblown fibers comprising 92.5 weight percent of PP-1 and 7.5 weight percent of A-1. The absorbent layer of the multilayer absorbent composite of Inventive Examples 7-9 had a weight ratio of pulp fibers to polymer fibers that was 60/40 and a basis weight for each respective absorbent layer of 60 gsm. Each multilayer absorbent composite was embossed with a hexadot bond pattern.

The properties of Inventive Examples 3-9 were evaluated and are provided in Table 3 below.

TABLE 3
Properties of Inventive Examples 3-9

| | Basis | Dry | Wet | Wet | Wet | Wet | |
|---|---|---|---|---|---|---|---|
| Example | weight | Caliper | MDT | MDE | CDT | CDE | Absorbency |
| No. | (gsm) | (μm) | (N/5 cm) | (%) | (N/5 cm) | (%) | (%) |
| Inventive | 44.5 | 620 | 29.3 | 45.1 | 8.71 | 48.9 | 1071.3 |
| Example 3 | | | | | | | |
| Inventive | 43.0 | 600 | 28.6 | 47.8 | 7.81 | 78.5 | 1078.2 |
| Example 4 | | | | | | | |
| Inventive | 45.4 | 580 | 26.6 | 42.5 | 8.42 | 83.8 | 1095.7 |
| Example 5 | | | | | | | |
| Inventive | 45.8 | 680 | 27.9 | 40.4 | 8.21 | 72.6 | 1109.6 |
| Example 6 | | | | | | | |
| Inventive | 59.4 | 870 | 36.2 | 30.9 | 17.17 | 45.4 | — |
| Example 7 | | | | | | | |
| Inventive | 58.8 | 800 | 38.1 | 31.7 | 18.83 | 50.9 | — |
| Example 8 | | | | | | | |
| Inventive | 57.8 | 750 | 38.1 | 31.0 | 18.85 | 49.7 | — |
| Example 9 | | | | | | | |

Values provided in Table 4 are based on an average of 6 samples.

As in the results provided with Inventive Examples 1 and 2, the presence of the cohesive layer in the multilayer absorbent composite significantly improved the mechanical properties of the composite in comparison to Comparative Examples 1 and 2. In particular, the Inventive Examples 3-9 having an SM cohesive layer with a basis weight of 12 g/m² exhibited significant increases in the mechanical properties in comparison to Comparative Example 1.

TABLE 4
Properties of Inventive Examples 3-9 Continued

| | | | | | Wet | Dry | Average | |
|---|---|---|---|---|---|---|---|---|
| | Basis | Dry | | | Mullen | Mullen | Mullen | |
| Example | weight | Caliper | Air Perm. | Opacity | Burst | Burst | Burst | Index of |
| No. | (gsm) | (μm) | (ft³/ft²/min) | (%) | (PSI) | (PSI) | (PSI) | Formation |
| Inventive | 44.5 | 620 | 84.9 | 66.9 | 15.0 | 15.5 | 15.25 | 42 ± 2.7 |
| Example 3 | | | | | | | | |
| Inventive | 43.0 | 600 | 73.7 | 66.6 | 15.0 | 15.0 | 15.0 | 40 ± 4.7 |
| Example 4 | | | | | | | | |
| Inventive | 45.4 | 580 | 87.5 | 65.5 | 14.0 | 14.5 | 14.25 | 41 ± 3.7 |
| Example 5 | | | | | | | | |
| Inventive | 45.8 | 680 | 86.8 | 65.5 | 14.0 | 14.5 | 14.25 | 40 ± 4.4 |
| Example 6 | | | | | | | | |
| Inventive | 59.4 | 870 | 79.3 | 71.1 | 19.5 | 19.5 | 19.5 | 36 ± 3.6 |
| Example 7 | | | | | | | | |
| Inventive | 58.8 | 800 | 75.9 | 69.3 | 18.5 | 18.5 | 18.5 | 37 ± 3.0 |
| Example 8 | | | | | | | | |
| Inventive | 57.8 | 750 | 73.5 | 69.0 | 17.0 | 17.5 | 17.25 | 39 ± 3.9 |
| Example 9 | | | | | | | | |

Values provided in Table 4 are based on an average of 6 samples.

In Table 5, below, the mechanical properties for Inventive Examples 4-6 were averaged and the mechanical properties for Inventive Examples 7-9. These averages were then compared to the results for Comparative Example 1 (see Table 6 below).

TABLE 5
Average Values for Examples 4-6 and Examples 7-9

| | | | | | | | | Wet |
|---|---|---|---|---|---|---|---|---|
| | Basis | Dry | Wet | Wet | Wet | Wet | | Mullen |
| | weight | Caliper | MDT | MDE | CDT | CDE | Absorbency | Burst |
| | (gsm) | (μm) | (N/5 cm) | (%) | (N/5 cm) | (%) | (%) | (PSI) |
| Average of | 44.7 | 620 | 27.7 | 43.6 | 8.15 | 78.3 | 1094.5 | 14.3 |
| Example | | | | | | | | |
| Nos. 4-6 | | | | | | | | |
| Average of | 58.7 | 807 | 37.5 | 31.2 | 18.28 | 48.7 | — | 18.5 |
| Examples | | | | | | | | |
| 7-9 | | | | | | | | |
| Comparative | 59.3 | 830 | 10.5 | 17.4 | 3.8 | 48.9 | 957.7 | 10.0 |
| Example 1 | | | | | | | | |

TABLE 6
Comparison of Inventive Examples 4-6 and 7-9 to Comparative Example 1

| | | | | | Increase Wet |
|---|---|---|---|---|---|
| | Increase in | Increase in | Increase in | Increase in | Mullen Burst |
| | Wet MDT | Wet MDE | Wet CDT | Wet CDE | strength |
| Sample Comparison | (%) | (%) | (%) | (%) | (%) |
| Inventive Examples 4-6 vs. | 163.8 | 150.6 | 114.5 | 60.1 | 43 |
| Comparative Example 1 | | | | | |
| Inventive Examples 7-9 vs. | 257.1 | 79.3 | 381.1 | −0.5 | 85 |
| Comparative Example 1 | | | | | |

From Tables 5 and 6, it is seen that the presence of the cohesive layer substantially increased the mechanical properties of the multilayer absorbent composite in comparison to a coform nonwoven that did not include the cohesive layer. In particular, the Wet MDT for the inventive examples exhibited increases in Wet MDT ranging from 75 to 160 percent and increases in the Wet MDE ranging from about 100 to 145 percent in comparison to the comparative examples. Similarly, the Wet CDT for the inventive examples exhibited increases in Wet CDT ranging from about 100 to 381 percent and increases in the Wet CDE ranging from about 50 to 75 percent in comparison to the comparative examples. The Average Wet CDS for Examples 7-9 remained about the same in comparison to Comparative Example 1.

As previously discussed, the drastic increase in mechanical properties while the multilayer absorbent composite is in a wet state is surprising in view that the cohesive layer is present in a minor proportion based on the overall weight of the multilayer absorbent composite. Both the inventive and comparative examples had similar basis weights; however, the inclusion of the cohesive layer provided a composite nonwoven having superior mechanical properties, which results in the multilayer absorbent composite being particularly useful as a wet wipe.

The inventive multilayer absorbent composites also demonstrated improvements with respect to the Mullen Burst Strength of the composite. As seen in Table 6, the multilayer absorbent composites exhibited average increases in a Wet Mullen Burst strength greater than 40 percent, and in particular, increases ranging from about 40 to 90 percent in comparison to the nonwoven fabrics of the comparative example. Mullen Burst strength provides a good representation of a material's ability to resist perforation. The inventive examples demonstrate that the inventive multilayer absorbent composites have improved properties with respect to the reduction and/or prevention in the formation of tears, rips, punctures, holes and the like in the multilayer absorbent composite.

In addition, the Coefficient of Friction (COF) for a dual textured wipe was also investigated. In Inventive Example 10, a multilayer absorbent wipe was prepared comprising a cohesive layer having an SSMM configuration (spunbond-spunbond-meltblown-meltblown) and a coform layer comprising a blend of meltblown and pulp fibers.

### Inventive Example 10

Inventive Example 10 was prepared by providing a layer of SSMM-1 that was continuously unwound from a nonwoven supply roll comprising SSMM-1 to define a cohesive layer. The cohesive layer was then passed through the line below the coform forming apparatus of Inventive Example 1 for forming an absorbent layer. The cohesive layer was oriented and arranged so that the absorbent layer was formed overlying the spunbond layer such that the meltblown layer of SSMM-1 defined an exterior surface of the multilayer absorbent composite.

In the coform forming apparatus both Meltblown beams A and B provided a stream of meltblown fibers comprising PP-1. The pulp stream comprised the PULP wood pulp fibers. The weight ratio of pulp fibers to polymer fibers in the absorbent layer was 60/40 and the targeted basis weight of the absorbent layer was 45 gsm.

In Inventive Example 10, one of the exterior surfaces of the multilayer absorbent composite comprises the coform material, which comprises a blend of meltblown fibers and pulp fibers. In the coform forming apparatus described above, the pulp stream is introduced between a pair of converging streams comprising meltblown fibers (from Meltblown beams A and B). Generally, this results in the exterior regions of the coform material being predominantly meltblown fibers with a higher concentration of pulp fibers being disposed towards the center of the coform material. Depending on the angle of the meltblown beams, the percentage of meltblown fibers disposed towards the exterior surface of the coform material may range from 52 to 95%, based on the total number of fibers located at the surface of the coform material. Typically, the number percentage of meltblown fibers at the surface of the coform material is from 60 to 80%, based on the total number of fibers.

The opposite exterior surface of the multilayer absorbent wipe comprises the SSMM-1 in which the meltblown layers are oriented and arranged to define the outer surface of the composite. Accordingly, the exterior surface of the composite is formed from meltblown fibers.

### Reference Sample 1

A reference sample (similar to Inventive Example 1) was prepared similar to the process described above. The cohesive layer comprises an SMS in which the fibers of the spunbond layers comprised polypropylene filaments prepared from PP-5, and the meltblown fibers of the meltblown layer comprised polypropylene fibers prepared from PP-4. In the reference sample, one of the exterior surfaces comprises a blend of meltblown fibers and pulp fibers, and the opposite exterior surface comprises spunbond fibers.

In Table 7, below, the frictional properties of the exterior surfaces for Inventive Example 10 and the Reference Example were evaluated based on the static and dynamic coefficient of friction for each surface.

TABLE 7
Static and Dynamic COF for Inventive
Example 10 and Reference Sample 1

| | | | % Increase in COF |
|---|---|---|---|
| | Average | Average | static/dynamic of |
| | Static | Dynamic | Inv. Ex. 10 vs. |
| Surfaces Evaluated | COF | COF | Ref. Sample. 1 |
| Inventive Example 10 | 0.252 | 0.166 | — |
| (coform exterior surface) | | | |
| Inventive Example 10 | 0.158 | 0.070 | 192.6/6,900 |
| (meltblown fiber exterior | | | |
| surface) | | | |
| Reference Example | 0.145 | 0.056 | — |
| (coform exterior surface) | | | |
| Reference Example | 0.054 | 0.001 | — |
| (Spunbond fiber exterior | | | |
| surface) | | | |

Values provided in Table 4 are based on the average of 5 samples.

From Table 7, it can be seen that in Inventive Example 10, the surface of the SSMM comprising meltblown fibers has a significantly higher static and dynamic COF in comparison to the Reference Sample surface comprising a SMS and having spunbond fibers at the exterior surface. More specifically, the exterior surface of Inventive Example 10 consisting of the meltblown fibers of the SSMM exhibits a percent increase in the static COF 192.6% and a percent increase in dynamic COF of 6,900% in comparison to the spunbond exterior surface of the Reference Sample 1. This demonstrates that the exterior surface of the multilayer absorbent composite comprised of meltblown fibers exhibits an improved surface for wiping applications. This also results in a dual textured wipe in which the surface comprising the coform material provides a first COF (for both static and dynamic) while the second surface (comprising meltblown fibers of the SSMM or an SM) provide a second COF (for both static and dynamic) that is lower than the first COF (for both static and dynamic).

Modifications of the inventions set forth herein will come to mind to one skilled in the art to which the inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-119. (canceled)

120. A multilayer absorbent composite comprising a first cohesive layer selected from the group consisting of a nonwoven fabric and a film, and an absorbent layer overlying the first cohesive layer, the absorbent layer comprising a blend of meltblown fibers and a solid additive, wherein the multilayer absorbent composite exhibits a wet Mullen Burst Strength from about 10 psi or greater.

121. The multilayer absorbent composite according to claim 120, wherein the first cohesive layer comprises a nonwoven fabric selected from the group consisting of spunbond fabric, a meltblown fabric, a carded fabric, a resin bonded fabric, a cellulose-based fabric, and a multilayer composite fabric.

122. The multilayer absorbent composite according to claim 120, wherein the cohesive layer comprises a multilayer laminate having a spunbond-meltblown-spunbond structure, a spunbond-meltblown structure, or a spunbond-spunbond-meltblown-meltblown structure.

123. The multilayer absorbent composite according to claim 120, wherein the first cohesive layer comprises a film.

124. The multilayer absorbent composite according to claim 120, wherein the basis weight of the cohesive layer is from about 6 to 30 gsm.

125. The multilayer absorbent composite according to claim 120, wherein the multilayer absorbent composite comprises first and second absorbent layers and the cohesive layer is sandwiched between the first and second absorbent layers.

126. The multilayer absorbent composite according to claim 120, wherein the cohesive layer comprises a cellulose-based tissue layer.

127. The multilayer absorbent composite according to claim 126, wherein the absorbent layer is sandwiched between a pair of tissue layers, and wherein the tissue layers have a basis weight from about from about 10 to 30 gsm.

128. The multilayer absorbent composite according to claim 120, wherein the solid additive comprises pulp fibers.

129. The multilayer absorbent composite according to claim 120, wherein the meltblown fibers comprise a polymeric blend of a polypropylene resin and an elastomeric polyolefin selected from the group consisting of a propylene-alpha-olefin copolymer and a low isotacticity polypropylene polymer.

130. The multilayer absorbent composite according to claim 120, wherein at least a portion of the meltblown fibers comprise a blend of a polypropylene resin and an elastomeric polyolefin in which the polypropylene resin has a molecular weight ranging from any of 120,000 to 300,000 g/mol, a melting temperature from about 150° C. to about 175° C., and wherein the polypropylene resin comprises a Ziegler-Natta catalyzed polypropylene, a metallocene catalyzed polypropylene, or a blend thereof, the elastomeric polypropylene being present in the polymer blend in an amount ranging from about 2 to 30 weight percent, based on the total weight of the polymer blend, and the elastomeric polyolefin is selected from the group consisting of a propylene-alpha-olefin copolymer and a low isotacticity polypropylene polymer.

131. The multilayer absorbent composite according to claim 120, wherein the absorbent layer defines a first exterior surface comprising a blend of meltblown and pulp fibers, and the first exterior surface exhibits a static Coefficient of Friction (COF) from about 0.145 to 0.165 and a dynamic COF from about 0.05 to 0.080; and the cohesive layer defines a second exterior surface comprising meltblown fibers in which the second exterior surface exhibits a static COF from about 0.225 to 0.275 and a dynamic COF from about 0.135 to 0.175.

132. The multilayer absorbent composite according to claim 131, wherein the first exterior surface exhibits a static COF that is from about 30 to 90% greater than that of the opposite exterior surface of the multilayer absorbent composite, and a dynamic COF that is from about 120 to 160% greater than that of the opposite exterior surface of the multilayer absorbent composite.

133. The multilayer absorbent composite according to claim 120, wherein the multilayer absorbent composite exhibits a dry and/or wet machine direction tensile strength (MDT) ranging from about 10 to 65 N/5 cm, a dry and/or wet machine direction elongation (MDE) ranging from about 20 to 100, a dry and/or wet cross direction tensile strength (CDT) ranging from about 10 to 25 N/5 cm, and a dry and/or wet cross direction elongation (CDE) ranging from about 40 to 120%.

134. The multilayer absorbent composite according to claim 120, wherein the multilayer absorbent composite exhibits a wet Mullen Burst Strength is from about 14 to 24 psi.

135. The multilayer absorbent composite according to claim 120, wherein the multilayer absorbent composite exhibits two or more of the following:
i) a wet machine direction tensile strength (MDT) ranging from about 15 to 60 N/5 cm, and in particular, from about 30 to 45 N/5 cm, and more particularly, from about 35 to 40 N/5 cm;
ii) a wet machine direction elongation (MDE) ranging from about 30 to 100%, and in particular, from about 35 to 75%, and more particularly, from about 50 to 75%;
iii) a wet cross direction tensile strength (CDT) ranging from about 10 to 25 N/5 cm, and in particular, from about 12 to 20 N/5 cm, and more particularly, from about 14 to 18 N/5 cm;
iv) a wet cross direction elongation (CDE) ranging from about 60 to 100%, and in particular, from about 62 to 85%, and more particularly, from about 70 to 80%; and
v) a wet Mullen Burst strength ranging from about 12 to 24 psi, and in particular, from about 17 to 20 psi, and more particularly, from about 18 to 19 psi.

136. The multilayer absorbent composite according to claim 120, wherein the multilayer absorbent composite exhibits two or more of the following:
i) increase in wet MDT ranging from about 225 to 300%, and in particular, from about 250 to 280% in comparison to an identically/similarly prepared nonwoven fabric that does not include the cohesive layer;
ii) an increase in MDE ranging from about 75 to 180%, and in particular, from about 100 to 150% in comparison to an identically/similarly prepared nonwoven fabric that does not include the cohesive layer;
iii) an increase in wet CDT ranging from about 20 to 200%, and in particular, from about 70 to 175% in comparison to an identically/similarly prepared nonwoven fabric that does not include the cohesive layer;
iv) an increase in wet CDE ranging from about 20 to 75%, and in particular, from about 25 to 60% in comparison to an identically/similarly prepared nonwoven fabric that does not include the cohesive layer; and
v) an increase in wet Mullen Burst Strength ranging from about 25 to 125%, and in particular, from about 30 to 100% in comparison to an identically/similarly prepared nonwoven fabric that does not include the cohesive layer.

137. A wipe comprising the multilayer absorbent composite according to claim 120.

138. A product assembly adapted to absorb liquids exuded from a product, comprising:
a substantially rigid support member having an upper surface upon which a product may be placed, and an opposing lower surface; and
an multilayer absorbent composite positioned overlying said support member, the multilayer absorbent composite comprising a first cohesive layer selected from the group consisting of a nonwoven fabric and a film, and an absorbent layer overlying the first cohesive layer, the absorbent layer comprising a blend of meltblown fibers and a solid additive, wherein the multilayer absorbent composite exhibits a wet Mullen Burst Strength from about 10 psi or greater.

139. A method of preparing a multilayer absorbent composite comprising the steps of:
providing a cohesive layer selected from the group consisting of a nonwoven fabric and a film;
depositing an absorbent layer comprising a blend of meltblown fibers and a solid additive overlying the cohesive layer, wherein the multilayer absorbent composite exhibits a dry/wet Mullen Burst Strength greater than 10 psi.
